(19) United States
(12) Patent Application Publication
(10) Pub. No.: US 2026/0322263 A1
(43) Pub. Date: Oct. 15, 2026

(54) METHOD AND CIRCUIT ARRANGEMENT FOR CONTROLLING A DC-DC POWER CONVERTER

(71) Applicant: Analog Devices International Unlimited Company, Limerick (IE)

(72) Inventors: Elio Consoli, Gravina di Catania (CT) (IT); Giuseppe Patti, Catania (CT) (IT); Giovana Battist Luca Fisichella, Belpasso (CT) (IT); Carmelo Ricca, Gravina di Catania (CT) (IT); Marco Masini, Milan (MI) (IT); Manuel Di Cera, Milan (MI) (IT)

(21) Appl. No.: 19/178,506

(22) Filed: Apr. 14, 2025

(51) Int. Cl. H02M 3/158; H02M 3/157

(52) U.S. Cl. CPC H02M 3/158; H02M 3/157

(57) ABSTRACT

The present disclosure relates to a method and controller for controlling a DC-DC power converter by regulating a first output voltage at a first output of the DC-DC power converter based on a first predetermined (specified) level, and a second output voltage at a second output of the DC-DC power converter based on a second predetermined (specified) level. A plurality of switches of the DC-DC power converter are controlled so as to operate the DC-DC power converter in any one of a number of different modes based on the input voltage and the first and/or second output voltage.

### FIELD

This application relates to electrical power converters. Specifically, single input multiple output, SIMO, DC-DC power converters.

### BACKGROUND

DC-DC power converters may be used for may purposes, where a regulated supply of DC power is desired. For example, they may be used in electronic devices (such as mobile electronic devices, for example smart phones, tablet computers, laptop computers, etc.) to convert input DC power, which may be variable in size depending on the source of DC power, to a controlled DC power level for powering electronic circuits within the device, for example, displays (e.g., AMOLED displays).

### SUMMARY OF THE DISCLOSURE

In a first aspect, there is provided a method for controlling a DC-DC power converter, the method comprising: regulating a first output voltage at a first output of the DC-DC power converter based on a first predetermined or specified level, and a second output voltage at a second output of the DC-DC power converter based on a second predetermined or specified level, by: controlling a plurality of switches of the DC-DC power converter so as to operate the DC-DC power converter with a mode when the input voltage is greater than the magnitude of the first voltage, wherein the mode comprises: a first phase wherein the plurality of switches are controlled to couple a first terminal of an inductor of the DC-DC power converter to the input and couple a second terminal of the inductor to the first output such that the inductor is charged by a current that flows between the input and the first output; a second phase wherein the plurality of switches are controlled to couple the first terminal of the inductor to the input and couple the second terminal of the inductor to a reference voltage such that the inductor is charged by a current that flows between the input and the reference voltage; and, a third phase wherein the plurality of switches are controlled to couple the first terminal of the inductor to the second output (NEG) and couple the second terminal of the inductor to a reference voltage such that the inductor is discharged by a current that flows between the second output and the reference voltage. The method of the first aspect advantageously provides efficient serving of the first and second outputs with a single current pulse when the input voltage is greater than the magnitude of the first voltage.

In a second aspect, there is provided a method for controlling a DC-DC power converter, the method comprising: regulating a first output voltage at a first output of the DC-DC power converter based on a first predetermined or specified level, and a second output voltage at a second output of the DC-DC power converter based on a second predetermined or specified level, by: controlling a plurality of switches of the DC-DC power converter so as to operate the DC-DC power converter with a mode when the input voltage is less than the magnitude of the first voltage, wherein the mode comprises: a first phase wherein the plurality of switches are controlled to couple a first terminal of an inductor of the DC-DC power converter to the input and couple a second terminal of the inductor to the reference voltage such that the inductor is charged by a current that flows between the input and the reference voltage; a second phase wherein the plurality of switches are controlled to couple the first terminal of the inductor to the second output and couple the second terminal of the inductor to a reference voltage such that the inductor is discharged by a current that flows between the second output and the reference voltage; and, a third phase wherein the plurality of switches are controlled to couple the first terminal of the inductor to the input and couple the second terminal of the inductor to the first output such that the inductor is discharged by a current that flows between the input and the first output.

The method of the second aspect advantageously provides efficient serving of the first and second outputs with a single current pulse when the input voltage is less than the magnitude of the first voltage.

In a third aspect, there is provided a method for controlling a DC-DC power converter, the method comprising: regulating a first output voltage at a first output of the DC-DC power converter based on a first predetermined or specified level, and a second output voltage at a second output of the DC-DC power converter based on a second predetermined or specified level, by: controlling a plurality of switches of the DC-DC power converter so as to operate the DC-DC power converter with a mode, wherein the mode comprises: a first phase wherein the plurality of switches are controlled to couple a first terminal of an inductor of the DC-DC power converter to the input and couple a second terminal of the inductor to a reference voltage such that the inductor is charged by a current that flows between the input and the reference voltage; a second phase wherein the plurality of switches are controlled to couple a first terminal of the inductor to the first output and couple a second terminal of the inductor to the second output such that the inductor discharges and a current flows between the first output and the second output.

The mode may further comprise a third phase wherein the plurality of switches are controlled to couple: a first terminal of the inductor to the first output (POS) and couple a second terminal of the inductor to the reference voltage (GND) such that the inductor discharges and a current flows between the first output (POS) and the reference voltage (GND); or a first terminal of the inductor to the second output (NEG) and couple a second terminal of the inductor to the reference voltage (GND) such that the inductor charges and a current flows between the second output (NEG) and the reference voltage (GND).

The method of the third aspect advantageously provides efficient serving of the first and second outputs with a single current pulse when the input voltage is greater than the magnitude of the first voltage plus the magnitude of the second voltage.

Furthermore, when the mode includes the third phase, charge balancing between the first output and the second output may be achieved within a single differential pulse (i.e., a single pulse comprising the first, second and third phases) when the input voltage is greater than a sum of the magnitude of the first output voltage and the magnitude of the second output voltage.

New current pulse shapes of the first, second, and third aspects are provided to efficiently balance charges at the outputs of the DC-DC power converter. A single differential current pulse serves two outputs the DC-DC power converter to achieve charge balancing.

In a fourth aspect, there is provided a method for controlling a DC-DC power converter, the method comprising: regulating a first output voltage at a first output of the DC-DC power converter based on a first predetermined or specified level, and a second output voltage at a second output of the DC-DC power converter based on a second predetermined or specified level, by: controlling a plurality of switches of the DC-DC power converter so as to operate the DC-DC power converter with a first mode when the input voltage is greater than the first output voltage; and controlling the plurality of switches to operate the DC-DC power converter with a second mode when the input voltage is less than the first output voltage, wherein the first mode is different to the second mode, and wherein the first mode and the second mode both comprise: a phase during which current flows at the first output; and a further phase during which current flows at the second output.

The method of the fourth aspect advantageously provides an adaptable and efficient control of a DC-DC power converter which is configured to adapt a current pulse shape in response to a change in input voltage to maintain efficient operation.

In a fifth aspect, there is provided a controller for controlling a DC-DC power converter, the controller arranged to couple to a first output and a second output of a DC-DC power converter, and configured to: receive the first output voltage from the first output; receive the second output voltage at the second output; control a plurality of switches of a DC-DC power converter to operate the DC-DC power converter with a first mode to: regulate the first output voltage based on the first predetermined or specified voltage level; and, regulate the second output voltage based on the second predetermined or specified voltage level, wherein the first mode comprises: a first phase during which an inductor of the DC-DC power converter is charged; a second phase during which the charge of the inductor is adjusted; and a third phase during which the inductor is discharged, wherein during at least one of the phases, current flows at the first output, wherein during at least one of the phases, current flows at the second output, and wherein the second phase is operated for a duration based on the first output voltage and the second output voltage.

The method of the fifth aspect advantageously provides a controller to efficiently generate a current pulse for serving the first and second outputs to achieve charge balancing. In addition, the controller enables the generation of new current pulse shapes with multiple modes of operation.

In a sixth aspect, there is provided a controller for controlling a DC-DC power converter, the controller arranged to couple to a first output and a second output of a DC-DC power converter, and configured to: receive a first output voltage from the first output; receive a second output voltage at the second output; control a plurality of switches of a DC-DC power converter to operate the DC-DC power converter to generate a differential current pulse to: regulate the first output voltage based on the first predetermined or specified voltage level; and, regulate the second output voltage based on the second predetermined or specified voltage level; determine a load imbalance condition based on the first output voltage, the second output voltage, and an imbalance threshold; when the load imbalance condition is determined: the controller is configured to control a plurality of switches of a DC-DC power converter to operate the DC-DC power converter to generate a standalone current pulse to serve one of: the first output; or, the second output.

The method of the sixth aspect advantageously controls a power converter to detect such a load imbalance and supply a standalone current pulse to quickly resolve the large load imbalance.

In a seventh aspect, there is provided a controller for controlling a DC-DC power converter, the controller arranged to couple to a first output, a second output, and a third output of a DC-DC power converter, and configured to: receive a first output voltage from the first output; receive a second output voltage at the second output; receive a third output voltage at the third output; generate a queue of requests for operating the DC-DC power converter, wherein the queue of requests is a First-In-First-Out, FIFO, queue, wherein each request of the queue of requests corresponds to one of the first, second, and third outputs for serving a respective one of the first, second, and third outputs; control a plurality of switches of a DC-DC power converter to operate the DC-DC power converter to generate one of a plurality of current pulses based on a first request of the queue of requests, wherein the plurality of current pulses comprises first, second, and third pulses, wherein during the first pulse, current flows at the first output for serving the first output, wherein during the second pulse, current flows at the second output for serving the second output, wherein during the third pulse, current flows at the third output for serving the third output; and, control a plurality of switches of a DC-DC power converter to operate the DC-DC power converter to generate one of a plurality of current pulses based on a second request of the queue of requests, after the DC-DC power converter is operated based on the first request.

The method of the seventh aspect power converter is advantageously operable to serve each output in a first-in-first-out, FIFO, queue. This enables efficient control of the power converter.

### BRIEF DESCRIPTION OF THE FIGURES

FIG. 1 illustrates a schematic circuit diagram of a single input multiple output, SIMO, DC-DC power converter.

FIG. 2 illustrates a graph of a first current pulse generated by operating a single input bipolar output, SIBO, or SIMO DC-DC power converter and suitable for regulating and balancing two outputs of the power converter.

FIG. 3 illustrates a graph of a second current pulse generated by operating a SIBO or SIMO DC-DC power converter and suitable for regulating and balancing two outputs of the power converter.

FIG. 4 illustrates a graph of a third current pulse generated by operating a SIBO or SIMO DC-DC power converter and suitable for regulating and balancing two outputs of the power converter.

FIG. 5 illustrates a flow diagram suitable for controlling a SIBO or SIMO DC-DC power converter.

FIG. 6 illustrates a schematic block wiring diagram of a controller coupled to a SIMO DC-DC power converter.

FIG. 7 illustrates a schematic block wiring diagram of a controller coupled to a SIMO DC-DC power converter.

FIG. 8 illustrates a schematic block wiring diagram of a controller coupled to a SIMO DC-DC power converter.

FIG. 9 illustrates two graphs corresponding to a ramp signal and the first current pulse of FIG. 2.

FIG. 10 illustrates two graphs corresponding to a ramp signal and the second current pulse of FIG. 3.

FIG. 11 illustrates a schematic block wiring diagram of a controller coupled to a SIMO DC-DC power converter.

FIG. 12 illustrates three graphs corresponding to two ramp signals and the third current pulse of FIG. 4.

FIG. 13 illustrates a schematic block wiring diagram of a controller coupled to a SIMO DC-DC power converter suitable for handling large load imbalances.

FIG. 14 illustrates a graph of a fourth current pulse generated by operating a SIBO or SIMO DC-DC power converter and suitable for regulating a single output of the power converter.

FIG. 15 illustrates a graph of a fifth current pulse generated by operating a SIBO or SIMO DC-DC power converter and suitable for regulating a single output of the power converter.

FIG. 16a illustrates a new request being added to a queue of requests for operating a SIBO or SIMO DC-DC power converter.

FIG. 16b illustrates a first request being executed from the front of a queue of requests for operating a SIBO or SIMO DC-DC power converter.

FIG. 16c illustrates a first request being executed from the front of a queue of requests for operating a SIBO or SIMO DC-DC power converter.

FIG. 17 illustrates a flow diagram suitable for controlling a SIBO or SIMO DC-DC power converter.

### DETAILED DESCRIPTION

As a brief non-limiting overview, the present disclosure provides a method and circuit arrangement for controlling a DC-DC power converter, specifically a single input multiple output, SIMO, DC-DC power converter (e.g., a single input, bipolar output, SIBO, DC-DC power converter). New current pulse shapes are provided to efficiently balance charges at the outputs of the DC-DC power converter. A single differential current pulse can serve two outputs of the DC-DC power converter to achieve charge balancing. The DC-DC power converter is configured to adapt a current pulse shape in response to a change in input voltage to maintain efficient operation. The circuit arrangement enables the generation of the new current pulse shapes with multiple modes of operation. Duration of one of the modes of operation is controlled to enable charge balancing. If a large load imbalance occurs between the outputs of the DC-DC power converter, the power converter is controlled to detect such a load imbalance and supply a standalone current pulse to quickly resolve the large load imbalance. The DC-DC power converter is also operated to serve each output in a first-in-first-out, FIFO, queue.

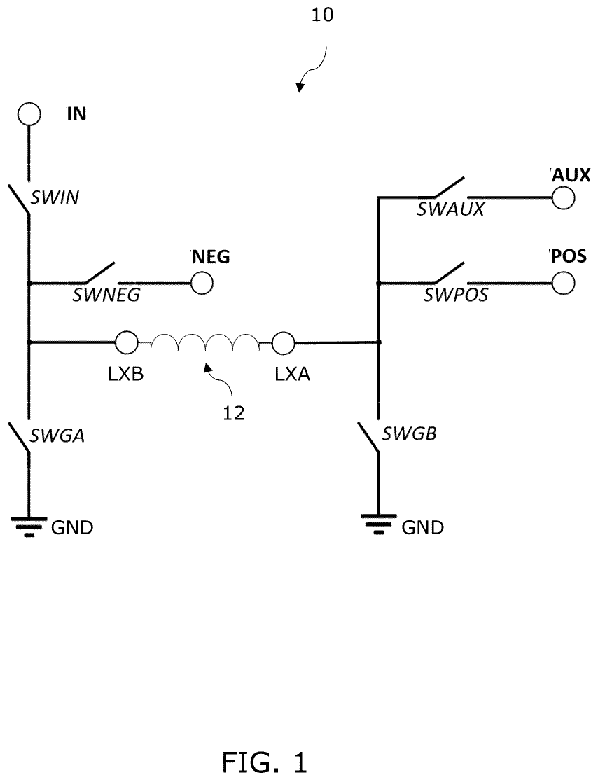

FIG. 1 shows a single input multiple output, SIMO, DC-DC power converter 10. The power converter 10 comprises an input node, IN, first output node POS (herein “POS output”), a second output node NEG (herein “NEG output”), a third output node AUX (herein “AUX output”), and a reference voltage node GND. The reference voltage node may be ground voltage, Vss, or other stable voltage used for reference purposes (herein the reference voltage node will be referred to as the “ground node”, and the reference voltage will be referred to as ground). The power converter 10 further comprises an inductor 12, and a plurality of switches. The inductor 12 comprises a first inductor node (also called first inductor terminal) LXA and a second inductor node (also called second inductor terminal) LXB, and the inductor is coupled between LXA and LXB. Each switch of the plurality of switches corresponds to each of the input node, output nodes, and ground node.

In the example, a first switch SWPOS of the plurality of switches is coupled between the POS output and the first inductor node LXA. A second switch SWNEG of the plurality of switches is coupled between the NEG output and the second inductor node LXB. A third switch SWIN of the plurality of switches coupled between the input node IN and the second inductor node LXB. A fourth switch SWGA of the plurality of switches coupled between the second inductor node LXB and the ground GND. A fifth switch SWGB of the plurality of switches coupled between the first inductor node LXA and the ground GND. In an example, a sixth switch SWAUX of the plurality of switches is coupled between the AUX output and the first inductor node LXA.

In an example, each switch of the plurality of switches may be a transistor, such as a FET (e.g., MOSFET), or a BJT.

In an alternative example, the power converter 10 may comprise further additional outputs each to provide a voltage at a corresponding regulated voltage. In an alternative example, the power converter 10 may comprise two outputs: the POS output, and the NEG output.

The power converter 10 may be particularly useful when used to provide power and balance charge within an AMOLED display load. AMOLED displays are used in various applications for their high energy efficiency and superior quality features. When the power converter 10 is coupled to a display load, the POS output may supply the current sources for pixel-level colour control, and the NEG output may be for controlling the display output power for brightness. Other than for small imbalances, the load may mostly recirculate between POS output and NEG output.

The power converter 10 may be controlled with a controller (e.g., control circuity, processor, etc.). The power converter 10 (or more specifically, the plurality of switches) may be controlled to regulate the first output voltage VPOS at the POS output of the power converter 10 based on a first predetermined or specified level. The first predetermined or specified level may be the voltage at which the first output voltage VPOS is regulated to. The power converter 10 (or more specifically, the plurality of switches) may be controlled to regulate the second output voltage VNEG at the NEG output of the power converter 10 based on a second predetermined or specified level. The second predetermined or specified level may be the voltage at which the second output voltage VNEG is regulated to.

The first output voltage VPOS and the second output voltage VNEG is regulated by controlling the plurality of switches of the power converter 10 so as to operate the power converter 10 with a first mode of operation when the input voltage VIN is greater than the magnitude of the first output voltage VPOS. The power converter 10 may be operated with the first mode when the input voltage VIN is greater than the magnitude of the first output voltage VPOS, and the input voltage VIN is less than the first output voltage VPOS plus the magnitude of the second output voltage VNEG, e.g., VPOS<VIN<VPOS+|VNEG|.

In an example, an initial margin threshold VTH0 may be used to determine if the power converter 10 is operated in the first mode. For example, the input voltage VIN may be less than the first output voltage VPOS plus the magnitude of the second output voltage VNEG subtract the initial margin threshold VTH0, e.g., VIN<VPOS+|VNEG|−VTH0. The initial margin threshold VTH0 may be 200, 250, or 300 mV. In addition or alternatively, in an example, a first margin threshold VTH1 may be used to determine if the power converter 10 is operated in the first mode. For example, the input voltage VIN may be greater than the magnitude of the first output voltage VPOS plus the first margin threshold, e.g., VIN>VPOS+VTH 1. The first margin threshold VTH1 may be 300, 350, or 400 mV. The addition of one or both of the initial and first margin threshold may be beneficial and may increase the efficiency of operating in the first mode.

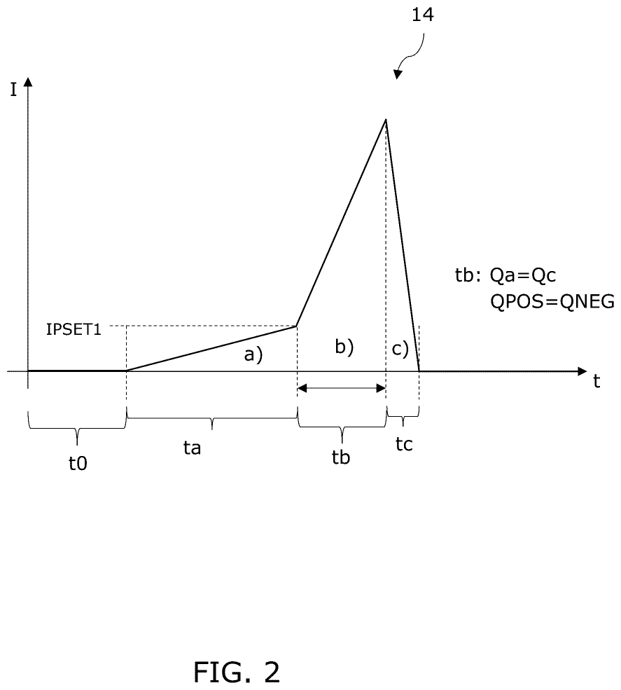

FIG. 2 shows a first current pulse 14 generated by operating the power converter 10 suitable for regulating the first output voltage VPOS, regulating the second output voltage VNEG, and balancing charge between the POS output and the NEG output. Time is shown on the x-axis, and current is shown on the y-axis. The first mode of the power converter 10 is configured to operate the power converter 10 to generate the first current pulse 14. Advantageously, the first mode may provide efficient operation of the power converter 10 by providing sufficient charge with a low current profile, allowing low current losses (R*I²).

As shown in FIG. 2, the first mode operates the power converter 10 to generate the first pulse 14 comprising three phases, a first phase (a), a second phase (b), and a third phase (c).

During the first phase (a) the plurality of switches are controlled to couple the second inductor node LXB of the inductor 12 to the input node IN, and couple the first inductor node LXA of the inductor 12 to the POS output node such that the inductor 12 is charged by a current that flows between the input node IN and the POS output node. During the first phase (a), the first switch SWPOS and the third switch SWIN of the plurality of switches are controlled to be closed, and the other switches of the plurality of switches (e.g., SWNEG, SWGA, SWGB, and, if present, SWAUX) are controlled to be open.

During the second phase (b) the plurality of switches are controlled to couple the second inductor node LXB of the inductor 12 to the input node IN, and couple the second terminal of the inductor to ground GND such that the inductor is charged by a current that flows between the input node IN and ground GND. During the second phase (b), the third switch SWIN and the fifth switch SWGB of the plurality of switches are controlled to be closed, and the other switches of the plurality of switches (e.g., SWPOS, SWNEG, SWGB, and, if present, SWAUX) are controlled to be open.

During the third phase (c) the plurality of switches are controlled to couple the second inductor node LXB of the inductor 12 to the NEG output node and couple the first inductor node LXA to ground GND such that the inductor 12 is discharged by a current that flows between the NEG output node and ground GND. During the third phase (c), the second switch SWNEG and the fifth switch SWGB of the plurality of switches are controlled to be closed, and the other switches of the plurality of switches (e.g., SWPOS, SWIN, SWGA, and, if present, SWAUX are controlled to be open.

The plurality of switches of the power converter 10 are controlled so as to operate the power converter 10 to transition from the first phase (a) to the second phase (b) in response to a comparison of: the current that flows between the input node IN and the POS output node; and a first current threshold IPSET1. As shown in FIG. 2, the current that flows between the input node IN and the POS output node raises until the first current threshold IPSET1 is reached, then the plurality of switches of the power converter 10 are controlled to operate the power converter 10 in accordance with the second phase (b).

When operating with the first mode, the first current threshold IPSET1 is not dependent on the input voltage at input IN. Advantageously, this allows for improved efficiency. The first current threshold IPSET1 can be predetermined or specified to provide efficient power conversion and voltage output ripple. The first current threshold IPSET1 may be predetermined or specified through experimentation for to a particular use case or application.

When operating in the first mode to generate the first pulse 14, the plurality of switches of the power converter 10 are controlled so as to operate the power converter 10 to transition from the second phase (b) to the third phase (c) when the duration tb of the second phase is reached. The duration tb of the second phase (b) is adjusted such that the charge provided to the NEG output node during the third phase (c) and the charge provided to the POS output node during the first phase (a) are those requested for the two outputs. There may be a moderate amount of imbalance between the charges provided to the POS output node and the NEG output node, or the charges provided to the POS output node and the NEG output node may be substantially equal/balanced. The terms “substantially equal” and “substantially balanced” may refer to the charge provided to the NEG output node being sufficiently similar to the charge provided to the POS output node such that an uninterrupted stream of multiple current pulses of the first mode can be produced to serve both the POS output node and the NEG output node steadily and seamlessly. Advantageously, charge balancing at the POS output node and the NEG output node in a single pulse may enable a seamless stream of differential pulses (i.e., each pulse serving both the POS output node and the NEG output node) without requiring (or minimising recourse to), standalone, charge balancing pulses that serve just one of the output nodes. As a result, great efficiency should be achieved.

The energy stored in the inductor 12 prior to the start of the first phase (a) of the first current pulse 14 is substantially the same as the energy stored in the inductor 12 at the end of the third phase (c). This will be the case during steady state operation, in either a discontinuous conduction mode, DCM, and a continuous conduction mode, CCM. As shown in the first current pulse 14, the current prior to the start of the first phase (a) is substantially the same as the current at the end of the third phase (c).

In the first mode, once the third phase (c) ends the power converter 10 may be operated with the first phase (a) of the first current pulse 14.

In an example, the plurality of switches of the power converter 10 may be controlled to operate the power converter 10 with a null phase (e.g., during t0) before the first phase (a) of the first current pulse 14. During the null phase each terminal of the inductor 12 is coupled to ground GND. During the null phase, the fourth switch SWGA and the fifth switch SWGB of the plurality of switches are controlled to be closed, and the other switches of the plurality of switches (e.g., SWPOS, SWNEG, SWIN, and, if present, SWAUX are controlled to be open. The power converter 10 is operated in the null phase when the power converter 10 is operated in a DCM. The power converter 10 may also be operated in the null phase when the power converter 10 is operated in a CCM, however, the duration of the null phase will be very short. In the first mode, once the third phase (c) ends the power converter 10 may be operated with the null phase.

The first output voltage VPOS and the second output voltage VNEG is regulated by controlling the plurality of switches of the power converter 10 so as to operate the power converter 10 with a second mode of operation when the input voltage VIN is less than (or equal to) the magnitude of the first output voltage VPOS.

In an example, a second margin threshold VTH2 may be used to determine if the power converter 10 is operated in the second mode. For example, the input voltage VIN may be less than the magnitude of the first output voltage VPOS subtract the second margin threshold, e.g., VIN<VPOS−VTH2. The second margin threshold VTH2 may be 300, 350, or 400 mV.

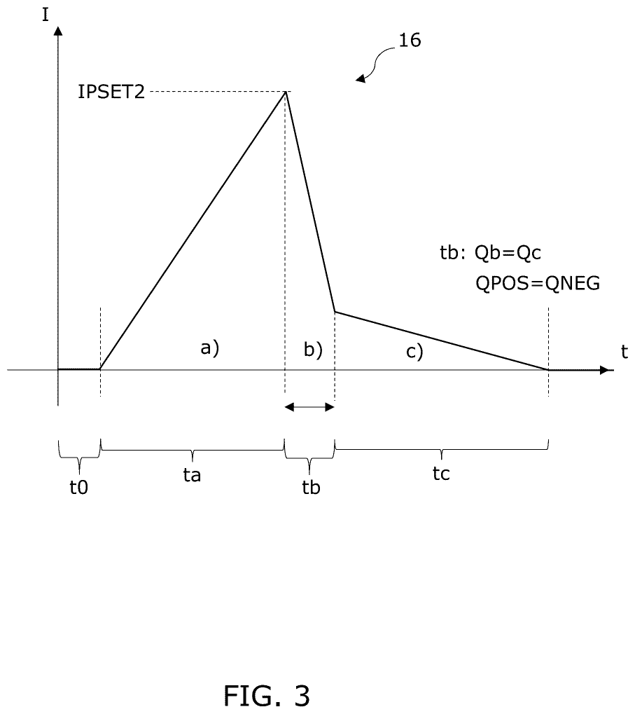

FIG. 3 shows a second current pulse 16 generated by operating the power converter 10 suitable for regulating the first output voltage VPOS, regulating the second output voltage VNEG, and balancing charge between the POS output and the NEG output. Time is shown on the x-axis, and current is shown on the y-axis. The second mode of the power converter 10 is configured to operate the power converter 10 to generate the second current pulse 16. Advantageously, the second mode may provide efficient operation of the power converter 10 by providing sufficient charge with a low current profile, allowing low current losses (R*I²).

As shown in FIG. 3, the second mode operates the power converter 10 to generate the second pulse 16 comprising three phases, a first phase (a), a second phase (b), and a third phase (c).

During the first phase (a) the plurality of switches are controlled to couple the second inductor node LXB of the inductor 12 of the power converter 10 to the input node IN and couple the first inductor node LXA of the inductor 12 to ground GND such that the inductor 12 is charged by a current that flows between the input node IN and ground GND. During the first phase (a), the third switch SWIN and the fifth switch SWGB of the plurality of switches are controlled to be closed, and the other switches of the plurality of switches (e.g., SWPOS, SWNEG, SWGA and, if present, SWAUX) are controlled to be open.

During the second phase (b) the plurality of switches are controlled to couple the second inductor node LXB of the inductor 12 to the NEG output node, and couple the first inductor node LXA of the inductor 12 to ground GND such that the inductor is discharged by a current that flows between the NEG output node and ground GND. During the second phase (b), the second switch SWNEG and the fifth switch SWGB of the plurality of switches are controlled to be closed, and the other switches of the plurality of switches (e.g., SWPOS, SWIN, SWGA, and, if present, SWAUX) are controlled to be open.

During the third phase (c) the plurality of switches are controlled to couple the second inductor node LXB of the inductor 12 to the input node IN and couple the first inductor node LXA to the POS output node such that the inductor 12 is discharged by a current that flows between the input node IN and the POS output node. During the third phase (c), the third switch SWIN and the first switch SWPOS of the plurality of switches are controlled to be closed, and the other switches of the plurality of switches (e.g., SWNEG, SWGA, SWGB and, if present, SWAUX are controlled to be open.

The plurality of switches of the power converter 10 are controlled so as to operate the power converter 10 to transition from the first phase (a) to the second phase (b) in response to a comparison of: the current that flows between the input node IN and ground GND; and a second current threshold IPSET2. As shown in FIG. 3, the current that flows between the input node IN and ground GND raises until the second current threshold IPSET2 is reached, then the plurality of switches of the power converter 10 are controlled to operate the power converter 10 in accordance with the second phase (b).

When operating with the second mode, the second current threshold IPSET2 is not dependent on the input voltage at input IN. Advantageously, this allows for improved efficiency. The second current threshold IPSET2 can be predetermined or specified to provide efficient power conversion and voltage output ripple. The second current threshold IPSET2 may be predetermined or specified through experimentation for to a particular use case or application.

When operating in the second mode to generate the second pulse 16, the plurality of switches of the power converter 10 are controlled so as to operate the power converter 10 to transition from the second phase (b) to the third phase (c) when the duration tb of the second phase is reached. The duration tb of the second phase (b) is adjusted such that the charge provided to the POS output node during the third phase (c) and the charge provided to the NEG output node during the second phase (b) are those requested for the two outputs. There may be a moderate amount of imbalance between the charges provided to the POS output node and the NEG output node, or the charges provided to the POS output node and the NEG output node may be substantially equal/balanced. The terms “substantially equal” and “substantially balanced” may refer to the charge provided to the NEG output node being sufficiently similar to the charge provided to the POS output node such that an uninterrupted stream of multiple current pulses of the first mode can be produced to serve both the POS output node and the NEG output node steadily and seamlessly. Advantageously, charge balancing at the POS output node and the NEG output node in a single pulse may enable a seamless stream of differential pulses (i.e., each pulse serving both the POS output node and the NEG output node) without requiring (or minimising recourse to), standalone, charge balancing pulses that serve just one of the output nodes. As a result, great efficiency should be achieved.

The energy stored in the inductor 12 prior to the start of the first phase (a) of the second current pulse 16 is substantially the same as the energy stored in the inductor 12 at the end of the third phase (c). This will be the case during steady state operation, in either a discontinuous conduction mode, DCM, and a continuous conduction mode, CCM. As shown in the second current pulse 16, the current prior to the start of the first phase (a) is substantially the same as the current at the end of the third phase (c).

In the second mode, once the third phase (c) ends the power converter 10 may be operated with the first phase (a) of the second current pulse 16.

In an example, the plurality of switches of the power converter 10 may be controlled to operate the power converter 10 with the null phase (e.g., during t0) before the first phase (a) of the second current pulse 16. In the second mode, once the third phase (c) ends the power converter 10 may be operated with the null phase.

The first output voltage VPOS and the second output voltage VNEG is regulated by controlling the plurality of switches of the power converter 10 so as to operate the power converter 10 with a third mode of operation. The third mode of operation may be used when VIN is greater than the magnitude of the first output voltage VPOS, or less than POS (or equal to) the magnitude of the first output voltage VPOS. The third mode may be advantageous when the input voltage VIN is greater than a sum of the magnitude of the first output voltage VPOS plus the magnitude of the second output voltage VNEG, e.g., VIN>|VPOS|+|VNEG|, as it enables change balancing between POS and NEG to be achieved even when VIN>|VPOS|+|VNEG|.

In an example, the initial margin threshold VTH0 may be used to determine if the power converter 10 is operated in the third mode. For example, the input voltage VIN may be greater than a sum of the magnitude of the first output voltage VPOS plus the magnitude of the second output voltage VNEG subtract the initial margin threshold, e.g., e.g., VIN>|VPOS|+|VNEG|−VTH0.

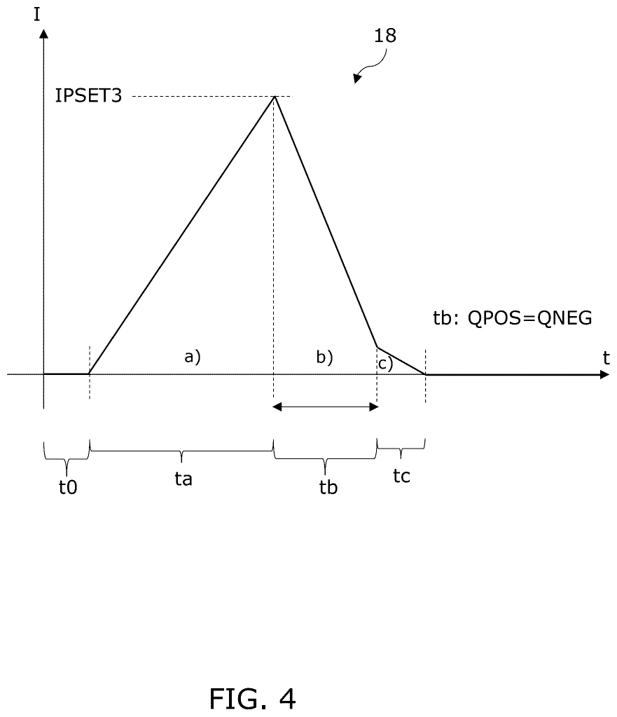

FIG. 4 shows a third current pulse 18 generated by operating the power converter 10 suitable for regulating the first output voltage VPOS, regulating the second output voltage VNEG, and balancing charge between the POS output and the NEG output. Time is shown on the x-axis, and current is shown on the y-axis. The third mode of the power converter 10 is configured to operate the power converter 10 to generate the third current pulse 18. Advantageously, the third mode may provide efficient operation of the power converter 10 by providing sufficient charge with a low current profile, allowing low current losses (R*I²).

As shown in FIG. 4, the third mode operates the power converter 10 to generate the third pulse 18 comprising three phases, a first phase (a), a second phase (b), and a third phase (c). However, the third pulse 18 may comprise only the first phase (a) and the second phase (b) if the charge provided to the POS output node is substantially equal to the charge provided to the NEG output node during the second phase (b). In an example, the third pulse 18 may comprise only the first phase (a) and the second phase (b) if the current prior to the start of the first phase (a) is substantially the same as the current at the end of the second phase (b).

However, if there is an imbalance between the load of the POS output node and the load of the NEG output node, then after the second phase (b) the amount of charge provided to the POS output and the NEG output may not service them in a way that compensates for the external load imbalance. Therefore, the third phase (c) may be necessary to serve one of the POS output node or the NEG output node to ensure that the charges provided to the POS and NEG outputs are the ones that are required in order to compensate for the external load imbalance.

During the first phase (a) the plurality of switches are controlled to couple the second inductor node LXB of the inductor 12 of the power converter 10 to the input node IN and couple the first inductor node LXA of the inductor 12 to ground GND such that the inductor 12 is charged by a current that flows between the input node IN and ground GND. During the first phase (a), the third switch SWIN and the fifth switch SWGB of the plurality of switches are controlled to be closed, and the other switches of the plurality of switches (e.g., SWPOS, SWNEG, SWGA and, if present, SWAUX) are controlled to be open.

During the second phase (b) the plurality of switches are controlled to couple the second inductor node LXB of the inductor 12 to the NEG output node, and couple the first inductor node LXA of the inductor 12 to the POS output node such that the inductor is discharged by a current that flows between the NEG output node and the POS output node. During the second phase (b), the first switch SWPOS and the second switch SWNEG of the plurality of switches are controlled to be closed, and the other switches of the plurality of switches (e.g., SWIN, SWGA, SWGB and, if present, SWAUX) are controlled to be open.

During the optional third phase (c) of the third pulse 18 the plurality of switches is controlled to either serve the POS output node or the NEG output node. In the third phase (c) of the third pulse 18, either the first inductor node LXA of the inductor 12 is coupled to the POS output node or the second inductor node LXB of the inductor 12 is coupled to the NEG output node, based on either the first output voltage VPOS or the second output voltage VNEG demanding more energy.

If the POS output node is served, then the plurality of switches is controlled to couple the second inductor node LXB of the inductor 12 to ground GND and couple the first inductor node LXA to the POS output node such that the inductor 12 is discharged by a current that flows between the POS output node and the ground GND. During the third phase (c) when the POS output is served, the fourth switch SWGA and the first switch SWPOS of the plurality of switches are controlled to be closed, and the other switches of the plurality of switches (e.g., SWIN, SWNEG, SWGB and, if present, SWAUX are controlled to be open.

If the NEG output node is served, then the plurality of switches is controlled to couple the second inductor node LXB of the inductor 12 to the NEG output node and couple the first inductor node LXA to ground GND such that the inductor 12 is discharged by a current that flows between the NEG output node and ground GND. During the third phase (c) when the NEG output is served, the second switch SWNEG and the fifth switch SWGB of the plurality of switches are controlled to be closed, and the other switches of the plurality of switches (e.g., SWPOS, SWIN, SWGB and, if present, SWAUX are controlled to be open.

The plurality of switches of the power converter 10 are controlled so as to operate the power converter 10 to transition from the first phase (a) to the second phase (b) in response to a comparison of: the current that flows between the input node IN and ground GND; and a third current threshold IPSET3. As shown in FIG. 4, the current that flows between the input node IN and ground GND raises until the third current threshold IPSET3 is reached, then the plurality of switches of the power converter 10 are controlled to operate the power converter 10 in accordance with the second phase (b).

When operating with the third mode, the third current threshold IPSET3 is not dependent on the input voltage at input IN. Advantageously, this allows for improved efficiency. The third current threshold IPSET3 can be predetermined or specified to provide efficient power conversion and voltage output ripple. The third current threshold IPSET3 may be predetermined or specified through experimentation for to a particular use case or application.

When operating in the third mode to generate the third current pulse 18, the plurality of switches of the power converter 10 are controlled so as to operate the power converter 10 to transition from the second phase (b) to the third phase (c), if the charge requested by VPOS and VNEG is imbalanced. The duration tb of the second phase (b) is adjusted such that the charge provided to the POS output node during the second and/or third phase, and the charge provided to the NEG output node during the second and/or third phase, are those requested for the two outputs. There may be a moderate amount of imbalance between the charges provided to the POS output node and the NEG output node, or the charges provided to the POS output node and the NEG output node may be substantially equal/balanced. The terms “substantially equal” and “substantially balanced” may refer to the charge provided to the NEG output node being sufficiently similar to the charge provided to the POS output node such that an uninterrupted stream of multiple current pulses of the first mode can be produced to serve both the POS output node and the NEG output node steadily and seamlessly. Advantageously, charge balancing at the POS output node and the NEG output node in a single pulse may enable a seamless stream of differential pulses (i.e., each pulse serving both the POS output node and the NEG output node) without requiring (or minimising recourse to), standalone, charge balancing pulses that serve just one of the output nodes. As a result, great efficiency should be achieved.

The energy stored in the inductor 12 prior to the start of the first phase (a) of the second current pulse 16 is substantially the same as the energy stored in the inductor 12 at the end of the third phase (c). This will be the case during steady state operation, in either a discontinuous conduction mode, DCM, and a continuous conduction mode, CCM. As shown in the third current pulse 18, the current prior to the start of the first phase (a) is substantially the same as the current at the end of the third phase (c).

In the third mode, once the third pulse 18 ends (i.e., after the second phase (b) or third phase (c)) the power converter 10 may be operated with the first phase (a) of the third current pulse 18.

In an example, the plurality of switches of the power converter 10 may be controlled to operate the power converter 10 with the null phase (e.g., during t0) before the first phase (a) of the third current pulse 18. In the third mode, once the third phase (c) ends (or after the second phase (b) ends, if no third phase (c) immediately follows) the power converter 10 may be operated with the null phase.

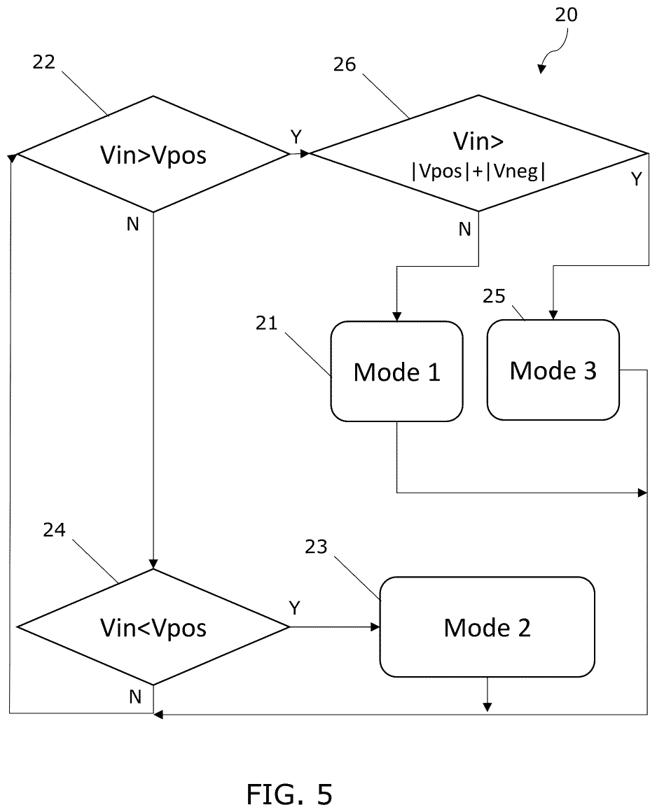

FIG. 5 shows an example flow diagram 20 for controlling the power converter 10. The plurality of switches of the power converter 10 are controlled so as to operate the power converter 10 with the first mode 21 (and/or the optional third mode 25) when the input voltage VIN is greater than the first output voltage VPOS (see first decision block 22). The plurality of switches of the power converter 10 are controlled so as to operate the DC-DC power converter with the second mode 23 when the input voltage VIN is less than the first output voltage VPOS (see second decision block 24). The first mode 21 is different to the second mode 23 (as described with reference to FIGS. 2 and 3). The first mode 21 and the second mode 23 both comprise a phase during which current flows at the POS output node, and a further phase during which current flows at the NEG output node.

Optionally, when the input voltage VIN is greater than the magnitude of the first output voltage VPOS plus the magnitude of the second output voltage VNEG, the (see third decision block 26), the plurality of switches of the power converter 10 are controlled so as to operate the power converter 10 with the third mode 25. In an alternative example, the power converter 10 may be operated with the third mode 25 if the input voltage VIN is greater than the first output voltage VPOS, or if the input voltage VIN is less than the first output voltage VPOS.

While the power converter 10 is controlled in the first mode 21, the plurality of switches of the power converter 10 are controlled so as to generate a series of one or more first current pulses 14 (as shown in FIG. 2) to regulate both the POS output node and the NEG output node. While the power converter 10 is controlled in the second mode 23, the plurality of switches of the power converter 10 are controlled so as to generate a series of second current pulses 16 (as shown in FIG. 3) to regulate both the POS output node and the NEG output node. While the power converter 10 is controlled in the third mode 25, the plurality of switches of the power converter 10 are controlled so as to generate a series of third current pulses 18 (as shown in FIG. 4) to regulate both the POS output node and the NEG output node.

Although the inequalities shown in the decision blocks 22, 24, 26 are described in FIG. 5 without margin thresholds, in alternative examples, the inequalities of the one or more of the decision blocks 22, 24, 26 may comprise a respective margin threshold in accordance with the descriptions with reference to FIGS. 2 to 4.

In an alternative example, the none of the decision blocks are present and the plurality of switches of the power converter 10 are controlled so as to operate the power converter 10 with a single mode (e.g., the first mode 21, the second mode 23, or the third mode 25). In an alternative example, the two of the decision blocks are present and the plurality of switches of the power converter 10 are controlled so as to operate the power converter 10 with two modes (e.g., the first mode 21, the second mode 23, and/or the third mode 25).

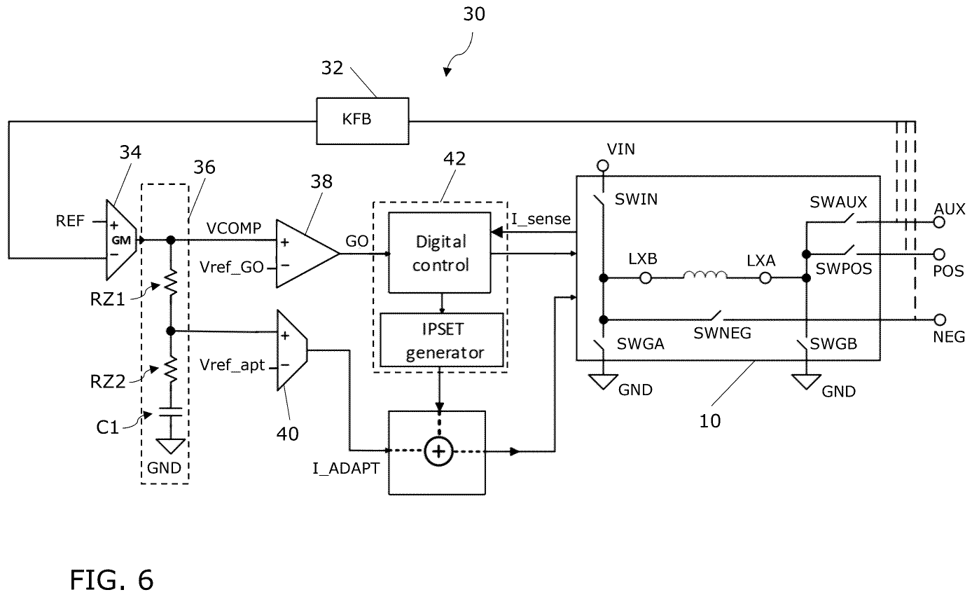

FIG. 6 shows an example of a schematic block wiring diagram of a controller 30 (such as a control circuit, and/or processor) coupled to a power converter 10 for carrying out the method in accordance with an example of the present disclosure. The controller 30 shows an arrangement for controlling a single output voltage from the power converter 10, e.g., from the POS output node, the NEG output node, or the AUX output node, for explanatory purpose. However, it will be understood that the controller 30 may comprise additional components suitable for regulating a corresponding output voltage.

The controller 30 comprises a first feedback buffer 32 arranged to receive an output voltage (e.g., from the POS output node, the NEG output node, or the AUX output node) and output a first feedback signal. In an example, the first feedback buffer 32 may be a unitary gain buffer. The first feedback signal is input into a first GM block 34 (e.g., an operational transconductance amplifier, OTA). The first GM block 34 receives as an input the first feedback signal and a first target voltage REF (e.g., the first predetermined or specified voltage level, or the second predetermined or specified voltage level).

The controller 30 is configured to integrate a comparison between the first feedback signal (i.e., representing an output voltage) to a first target voltage REF to generate a first integrated signal VCOMP. In the example of FIG. 6, the first GM block 34 provides an output to a first integrator 36. The first integrator 36 may be a RC integrator configured to couple the output of the first integrator 36 to ground GND via a series resistor RZ1, RZ2 and capacitor C1.

The controller 30 is configured to compare the first integrated signal VCOMP to a first regulation reference level Vref_GO to generate a first request GO corresponding to the first output. In the example of FIG. 6, a first comparator 38 is arranged to receive the first integrated signal VCOMP from the output of the first integrator 36 and the first regulation reference level Vref_GO. The first comparator 38 is arranged to generate the first request GO.

The controller 30 is configured to receive the first request GO and in response, control the power converter 10 to generate a current pulse (e.g., corresponding to the first current pulse 14, second current pulse 16, third current pulse 18, or any other current pulse). In a discontinuous current mode, DCM, each received request GO generates a respective current pulse. As such, the more requests GO received, the greater the frequency of current pulses. In the example of FIG. 6, a control block 42 is arranged to receive the first request GO, and optionally current measurement information from the power converter 10. The control block 42 is arranged to control the plurality of switches, and select a current threshold (e.g., IPSET1, IPSET2, IPSET3, etc.) corresponding to the operating mode of the controller 30.

The controller 30 is configured to determine a continuous conduction mode, CCM, and generate a base current I_ADAPT. The base current I_ADAPT is added to the selected current threshold, such that the selected current threshold is relative to the current immediately prior to a first phase (a) of a current pulse. In the example of FIG. 6, a first adapt GM block 40 is arranged to receive a signal from the output of the first integrator 36 (between RZ1 and RZ2) and the first base current reference level Vref_apt. The first adapt GM block 40 is arranged to generate the base current I_ADAPT.

The power converter 10 enters CCM when the current pulses become maximally packed, and the current can no longer return to a non-conducting mode between pulses. The current pulses may become maximally packed if the frequency of requests GO received exceeds a threshold. When this threshold is exceeded the base current I_ADAPT may become non-zero.

In an alternative example, anther controller may be provided suitable for controlling the power converter 10 to generate at least one of the first current pulse 14, the second current pulse 16, and the third current pulse 18.

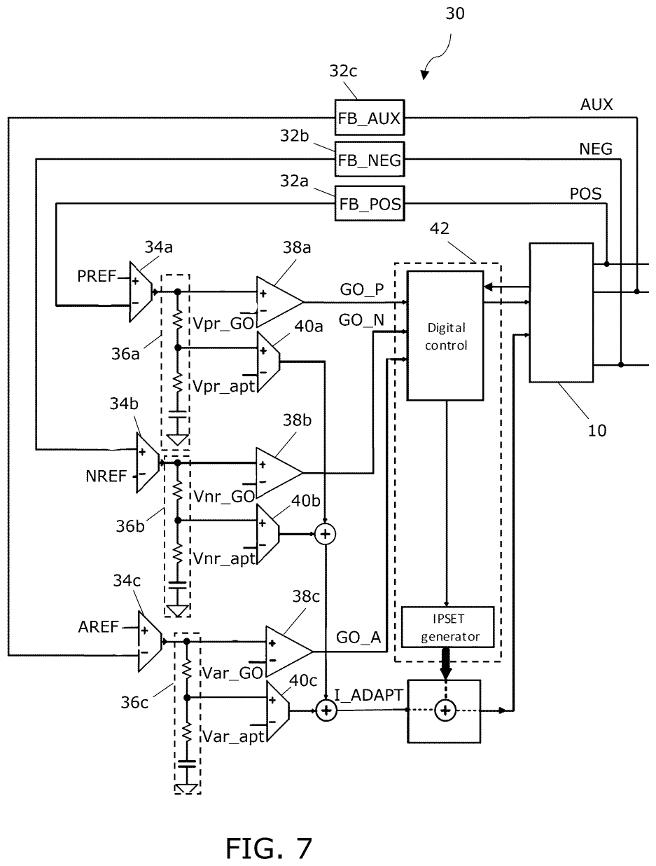

FIG. 7 shows an example of a schematic block wiring diagram of a controller 30 for performing a method described herein. The controller 30 of FIG. 7 shows an example of the controller 30 of FIG. 6. The controller 30 of FIG. 7 shows all of the features of the controller 30 of FIG. 6, in addition to additional components suitable for regulating a corresponding output voltage based on receiving a respective output voltage. That is, components are shown to regulate the first output voltage VPOS based on receiving the first output voltage VPOS from the first output POS (and the first predetermined or specified voltage level PREF). Similarly, components are shown to regulate the second output voltage VNEG based on receiving the second output voltage VNEG from the second output NEG (and the second predetermined or specified voltage level NREF), and optionally components are shown to regulate one or more third output voltage VAUX based on receiving the third output voltage VAUX from the third output AUX (and the third predetermined or specified voltage level AREF). The same reference numerals are used to denote the same/corresponding features in relation to FIG. 6 and will not be described in detail again below.

The function of controller 30 of FIG. 7 corresponding to each output voltage is similar to the function of the controller of FIG. 6 corresponding to the output voltage. That is, the controller 30 is configured to integrate a comparison between the first output voltage VPOS to the first predetermined or specified voltage level PREF to generate a first integrated signal VCOMP_POS. The controller 30 is further configured compare the first integrated signal VCOMP_POS to a first regulation reference level Vpr_GO to generate a first request GO_P corresponding to the first output POS. Specifically, the controller 30 of FIG. 7 comprises a first feedback buffer 32a, a first GM block 34a, a first integrator 36a, a first comparator 38a, and a first adapt GM block 40a corresponding to the first feedback buffer 32, the first GM block 34, the first integrator 36, the first comparator 38, and the first adapt GM block 40 of FIG. 6 respectively, and will not be described in detail again below.

In the example of FIG. 7, the controller 30 is configured to integrate a comparison between the second output voltage VNEG to the second predetermined or specified voltage level NREF to generate a second integrated signal VCOMP_NEG. The controller 30 is further configured compare the second integrated signal VCOMP_NEG to a second regulation reference level Vnr_GO to generate a second request GO_N corresponding to the second output NEG. Specifically, the controller 30 of FIG. 7 comprises a second feedback buffer 32b, a second GM block 34b, a second integrator 36b, a second comparator 38b, and a second adapt GM block 40b corresponding to the first feedback buffer 32, the first GM block 34, the first integrator 36, the first comparator 38, and the first adapt GM block 40 of FIG. 6 respectively, and will not be described in detail again below. Optionally, the controller 30 of FIG. 7 comprises a third feedback buffer 32c, a third GM block 34c, a third integrator 36c, a third comparator 38c, and a third adapt GM block 40c corresponding to the first feedback buffer 32, the first GM block 34, the first integrator 36, the first comparator 38, and the first adapt GM block 40 of FIG. 6 respectively, and will not be described in detail again below.

Optionally, as shown in the example of FIG. 7, the controller 30 is configured to integrate a comparison between the third output voltage VAUX to a third predetermined or specified voltage level AREF to generate a third integrated signal VCOMP_AUX. The controller 30 is further configured compare the third integrated signal VCOMP_AUX to a third regulation reference level Var_GO to generate a third request GO_A corresponding to the second output NEG. Specifically, the controller 30 of FIG. 7 comprises a third feedback buffer 32c, a third GM block 34c, a third integrator 36c, a third comparator 38c, and a third adapt GM block 40c corresponding to the first feedback buffer 32, the first GM block 34, the first integrator 36, the first comparator 38, and the first adapt GM block 40 of FIG. 6 respectively, and will not be described in detail again below.

In an example, the base current I_ADAPT is added to the selected current threshold, such that the selected current threshold is relative to the current immediately prior to a first phase (a) of a current pulse. The base current I_ADAPT is generated from the sum of the first adapt GM block 40a output, the second adapt GM block 40b output, and the third adapt GM block 40c output.

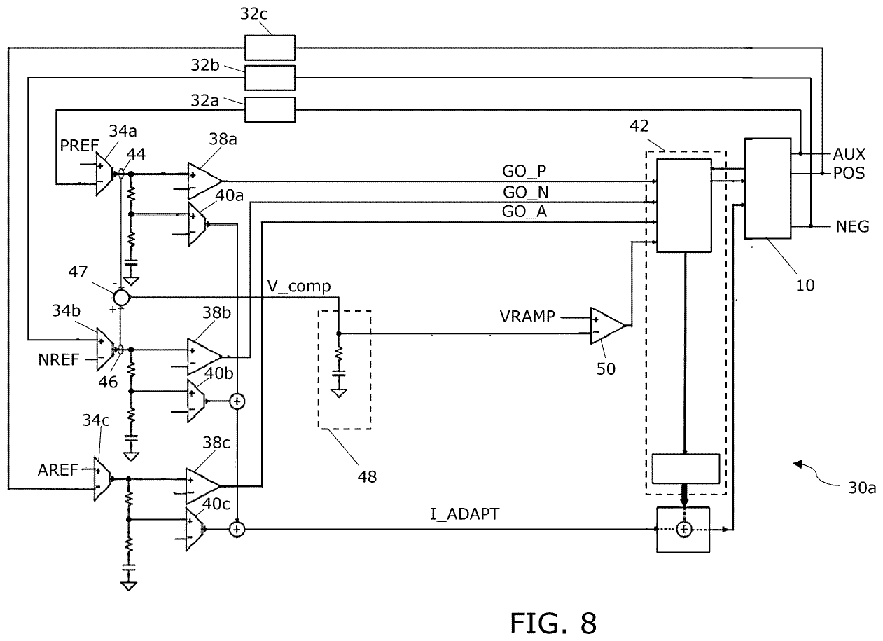

FIG. 8 shows an example of a schematic block wiring diagram of a controller 30a for performing a method described herein. The controller 30a of FIG. 8 shows an example of the controller 30 of FIG. 7. The controller 30a of FIG. 8 shows all of the features of the controller 30 of FIG. 7, in addition to additional components suitable for regulating a corresponding output voltage. The same reference numerals are used to denote the same/corresponding features in relation to FIG. 7 and will not be described in detail again below.

The controller 30a is configured to control a plurality of switches of the power converter 10 to operate the power converter 10 with any mode of operation comprising at least a first phase during which the inductor 12 of the power converter 10 is charged, and a second phase during which the inductor 12 is discharged. Preferably, the power converter 10 is operated with a mode of operation comprising at least a first phase during which the inductor 12 of the power converter 12 is charged, a second phase during which the charge of the inductor 12 is adjusted, and a third phase during which the inductor 12 is discharged.

The mode of operation of the controller 30a may operate the power converter 10 to generate a differential current pulse for serving two of the outputs (e.g., POS, NEG), or a standalone current pulse for serving one output (e.g., POS, NEG, AUX). An output is served when current is allowed to flow at said output. In an example, current flows at the first output POS in at least one phase of the mode of operation, and at the second output NEG in at least one other phase of the mode of operation, when the controller 30a is operates the power converter 10 to generate a differential current pulse. In an example, current flows at the first output POS in at least two phases of the mode of operation, when the controller 30a is operates the power converter 10 to generate a standalone current pulse.

In an example, the second phase of the mode of operation is operated for a duration based on the first output voltage VPOS and the second output voltage VNEG.

A method of determining the duration of the second phase may comprise the following steps:
a) compare a first signal corresponding to the first output voltage VPOS, to the first regulation voltage level PREF to generate a first comparison signal;
b) compare a second signal corresponding to the second output voltage VNEG, to a second regulation voltage level to generate a second comparison signal NREF;
c) generate an integrator signal based on integrating the difference of the first comparison signal and the second comparison signal; and,
d) compare the integrator signal to a ramp signal VRAMP.

The duration of the second phase is based on the comparison between the integrator signal and the ramp signal VRAMP.

FIG. 8 shows example components to perform the method of determining the duration of the second phase. Specifically, the first GM block 34a, the second GM block 34b, a current subtractor circuit (comprising current sensor 44, 46 and subtractor 47), a fourth integrator 48, and a ramp comparator 50.

In an example, a first signal is output from the first feedback buffer 32a based on the first output voltage PREF. The first GM block 34a is a first Operational Transconductance amplifier (OTA) arranged receive the first signal and the first regulation voltage level PREF to generate the first comparison signal. The first comparison signal is a current signal. A current sensor 44 is configured to sense the first comparison signal and provide a current representative of the first comparison signal to a subtractor 47. In an example, the current sensors 44, 46 may be implemented as a current mirror arrangement.

In an example, a second signal is output from the second feedback buffer 32b based on the second output voltage NREF. The second GM block 34b is a second OTA arranged receive the second signal and the second regulation voltage level NREF to generate the second comparison signal. The second comparison signal is a current signal.

In an example, the current subtractor circuit is arranged to receive the first comparison signal and the second comparison signal. The current subtractor circuit comprises an output. Specifically, the current subtractor circuit comprises a first current sensor 44 configured to sense the first comparison signal and provide a current representative of the first comparison signal to a subtractor 47. The current subtractor circuit comprises a second current sensor 46 configured to sense the second comparison signal and provide a current representative of the second comparison signal to the subtractor 47. The subtractor 47 is configured to generate an output representative of the difference between the current representative of the first comparison signal and the current representative of the second comparison signal.

In an example, the fourth integrator 48 is configured to receive the output of the subtractor 47 and provide a voltage signal to the ramp comparator 50. The fourth integrator 48 may comprise an RC circuit configured to couple to the output of the current subtractor circuit to ground via a series resistor and capacitor.

In an example, the ramp comparator 50 comprises an input coupled to the output of the subtractor 47 of the current subtractor circuit. The ramp comparator 50 is configured to compare the integrator signal to a ramp signal and generate, at the output of the ramp comparator 50, a phase transition signal to operate the power converter 10 to transition from the second phase to the third phase of a mode of operation.

The controller 30a is configured to control the plurality of switches of the power converter 10 to operate the power converter 10 with a mode in response to receiving a first request GO_P or a second requires GO_N. Specifically, the power converter 10 is operated to initiate the first phase of the mode in response to receiving a first request GO_P or a second request GO_N. The mode may be the first mode described in accordance with FIG. 2, the second mode described in accordance with FIG. 3, or the third mode described in accordance with FIG. 4.

As shown in FIG. 8, the first request GO_P is generated based on the first output voltage VPOS and, the first regulation reference level Vpr_GO. The second request GO_N is generated based on the second output voltage VNOS and, the second regulation reference level Vnr_GO.

When the controller 30a is operating in a mode of operation (e.g., one of the first, second, and third modes described with reference to FIGS. 2 to 4), and in response to receiving either of the first request GO_P or the second request GO_N, then the controller 30a is configured to initiate the first phase of the mode. If one of the first or second output nodes POS, NEG requires serving (indicated by the first or second request GO_P, GO_N respectively), then a current pulse may be generated to serve both of the first and second nodes POS, NEG.

The ramp signal VRAMP provided to ramp comparator 50 may be any suitable ramp signal. The ramp signal VRAMP may begin (or reset) when the second phase of the mode of operation begins. The ramp signal VRAMP may start at different starting levels, for example, for a voltage ramp signal, the ramp signal VRAMP may start varying its voltage from a starting voltage level. The starting voltage level may be 0V, any other fixed voltage, or may be a ratio of the VDD voltage. The ramp signal VRAMP may be a linear sloped ramp. In an alternative example, the ramp signal VRAMP may be a non-linear sloped ramp. The ramp signal VRAMP may be a rising or falling voltage signal. The ramp signal VRAMP may be determined based on various practical considerations known to the skilled person in the art such as, analog dynamic range, stability, and polarity of the analog control loop.

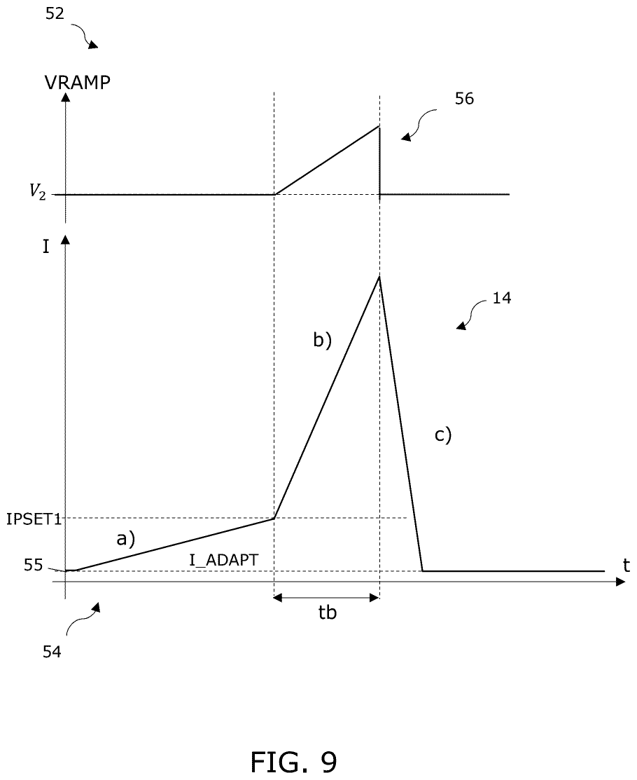

FIG. 9 shows two graphs 52 and 54 with a common time axis (x-axis, t). Specifically, FIG. 9 shows a first ramp graph 52, and a current graph 54. The first ramp graph 52 showing a first ramp 56. The current graph 54 showing the first current pulse 14. The first ramp 56 and the second phase (b) may begin in response to IPSET1 being reached.

In an example, the controller 30a is configured to control the plurality of switches to transition from the first phase (a) to the second phase (b) of the first current pulse 14 in response to a comparison of: the current that flows between the input node IN and the POS output; and the first current threshold IPSET1. As shown in FIG. 9, the first current threshold IPSET1 is relative to the base current I_ADAPT value 55. When the power converter 10 is operating in DCM, the base current I_ADAPT value 55 may be zero amps. When the power converter 10 is operating in CCM, the base current I_ADAPT value 55 may be non-zero, and determined prior to the first phase (a), e.g., immediately prior. The voltage V₂ at which the first ramp 56 starts to rise at the transition from the first phase (a) to the second phase (b) may be predetermined or specified based on analog dynamic range, stability, and/or polarity of the analog control loop.

In an example, the controller 30a is configured to control the plurality of switches to transition from the second phase (b) to the third phase (c). The second phase (b) is operated for the duration tb as described with reference to FIG. 2. Once the voltage of the first ramp 56 rises above (or equal to) the integrator signal, the output of the ramp comparator 50 changes resulting in a phase transition signal to control the plurality of switches to transition from the second phase (b) to the third phase (c), as shown in FIG. 9.

The controller is further configured to control the plurality of switches to end the third phase (c) in response to determining that the current (i.e., current that flows between the NEG output node and ground GND) is substantially equal to the base current I_ADAPT level 55, as shown in FIG. 9. The term “substantially equal” in the context of currents means that the currents are equal to within reasonable measurement tolerances. The current that flows between the NEG output node and ground GND reduces until the base current I_ADAPT is reached (e.g., a zero-crossing in DCM, or non-zero level in CCM), then the plurality of switches of the power converter 10 are controlled so as to operate the power converter 10 to end the first current pulse 14, or operate in the null phase.

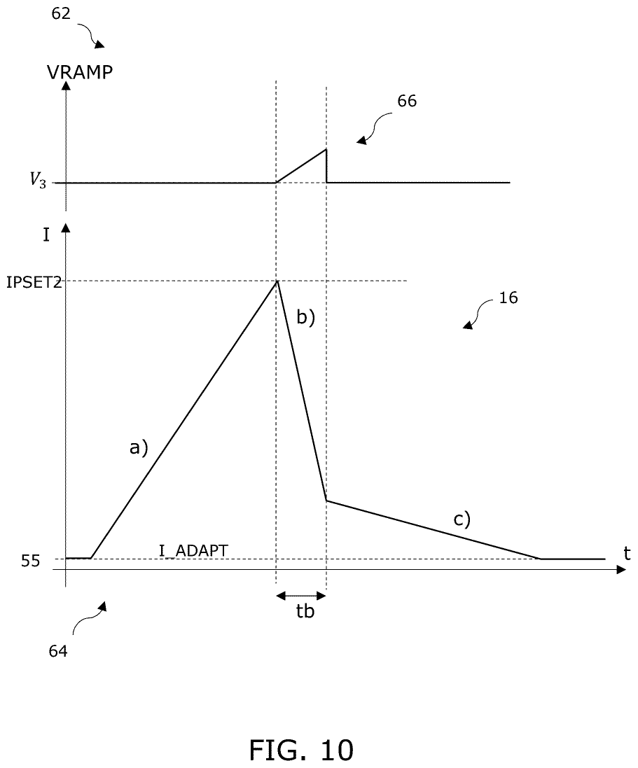

FIG. 10 shows two graphs 62 and 64 with a common time axis (x-axis, t). Specifically, FIG. 10 shows a second ramp graph 62, and a current graph 64. The second ramp graph 62 showing a second ramp 66. The current graph 64 showing the second current pulse 16. The second ramp 66 and the second phase (b) may begin in response to IPSET2 being reached.

In an example, the controller 30a is configured to control the plurality of switches to transition from the first phase (a) to the second phase (b) of the second current pulse 16 in response to a comparison of: the current that flows between the input node IN and ground GND; and the second current threshold IPSET2. As shown in FIG. 10, the second current threshold IPSET2 is relative to the base current I_ADAPT value 55. When the power converter 10 is operating in DCM, the base current I_ADAPT value 55 may be zero amps. When the power converter 10 is operating in CCM, the base current I_ADAPT value 55 may be non-zero, and determined prior to the first phase (a), e.g., immediately prior. The voltage V₃ at which the second ramp 66 starts to rise at the transition from the first phase (a) to the second phase (b) may be predetermined or specified based on analog dynamic range, stability, and/or polarity of the analog control loop.

In an example, the controller 30a is configured to control the plurality of switches to transition from the second phase (b) to the third phase (c). The second phase (b) is operated for the duration tb as described with reference to FIG. 3. Once the voltage of the second ramp 66 rises above (or equal to) the integrator signal, the output of the ramp comparator 50 changes resulting in a phase transition signal to control the plurality of switches to transition from the second phase (b) to the third phase (c), as shown in FIG. 10.

The controller is further configured to control the plurality of switches to end the third phase (c) in response to determining that the current (i.e., current that flows between the input node IN and the POS output node) is substantially equal to the base current I_ADAPT level 55, as shown in FIG. 10. The current that flows between the input node IN and the POS output node reduces until the base current I_ADAPT is reached (e.g., a zero-crossing in DCM, or non-zero level in CCM), then the plurality of switches of the power converter 10 are controlled so as to operate the power converter 10 to end the second current pulse 16, or operate in the null phase.

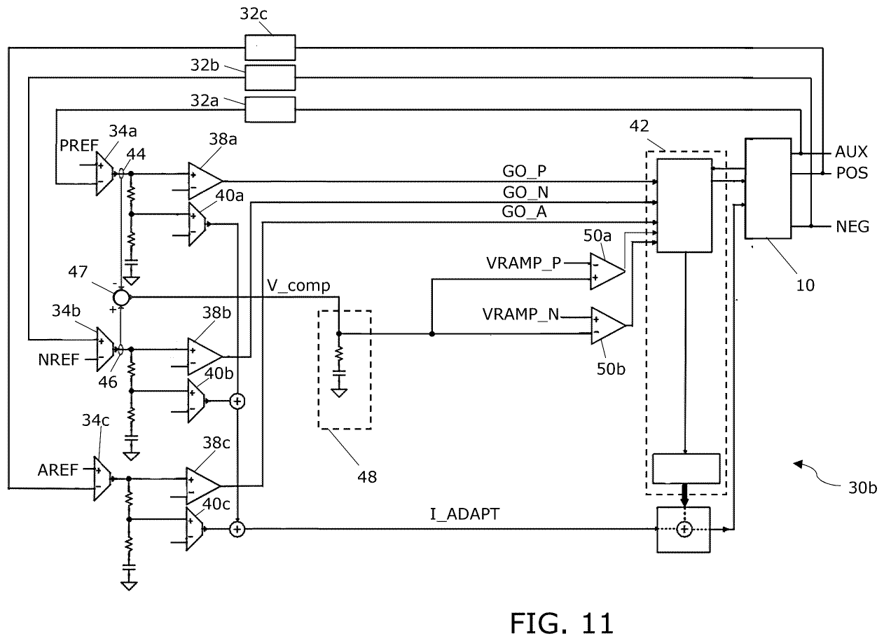

FIG. 11 shows an example of a schematic block wiring diagram of a controller 30b for performing a method described herein. The controller 30b is particularly beneficial when operated to regulate the POS output and the NEG output when the input voltage VIN is greater than a sum of the magnitude of the first output voltage VPOS plus the magnitude of the second output voltage VNEG. The controller 30b is configured to control a plurality of switches of the power converter 10 to operate the power converter 10 with the third mode of operation described with reference to FIG. 4 (although, the controller 30b may also operate with any mode of operation). The controller 30b of FIG. 11 shows all of the features of the controller 30a of FIG. 8, in addition to additional components suitable for regulating a corresponding output voltage. The same reference numerals are used to denote the same/corresponding features in relation to FIG. 8 and will not be described in detail again below. In particular, the controller 30b comprises at least an additional ramp comparator and ramp generation means.

In an example, the fourth integrator 48 is configured to receive the output of the subtractor 47 and provide a voltage signal to a first and a second ramp comparator 50a, 50b. The fourth integrator 48 may comprise an RC circuit configured to couple to the output of the current subtractor circuit to ground via a series resistor and capacitor.

In an example, each of the first and second ramp comparators 50a, 50b comprise an input coupled to the output of the subtractor 47 of the current subtractor circuit. The first ramp comparator 50a is configured to compare the integrator signal to a first ramp signal P_RAMP and generate, at the output of the first ramp comparator 50a, a phase transition signal to operate the power converter 10 to transition from the second phase to the third phase of a mode of operation. The second ramp comparator 50b is configured to compare the integrator signal to a second ramp signal N_RAMP and generate, at the output of the second ramp comparator 50b, a phase transition signal to operate the power converter 10 to transition from the second phase to the third phase of a mode of operation.

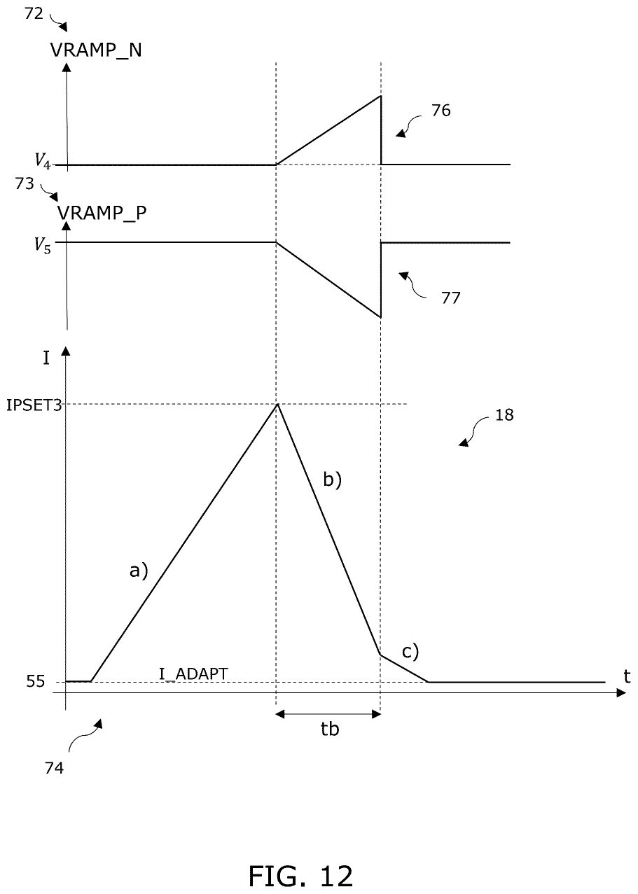

FIG. 12 shows three graphs 72, 73, and 74 with a common time axis (x-axis, t). Specifically, FIG. 12 shows a third ramp graph 72, a fourth ramp graph 73, and a current graph 74. The third ramp graph 72 showing the third ramp 76. The fourth ramp graph 73 showing the fourth ramp 77. The current graph 74 showing the third current pulse 18. The third and fourth ramps 76, 77 and the second phase (b) may begin in response to IPSET3 being reached.

In an example, the controller 30b is configured to control the plurality of switches to transition from the first phase (a) to the second phase (b) of the third current pulse 18 in response to a comparison of: the current that flows between the input node IN and ground GND; and the third current threshold IPSET3. As shown in FIG. 12, the third current threshold IPSET3 is relative to the base current I_ADAPT value 55. When the power converter 10 is operating in DCM, the base current I_ADAPT value 55 may be zero amps. When the power converter 10 is operating in CCM, the base current I_ADAPT value 55 may be non-zero, and determined prior to the first phase (a), e.g., immediately prior. The voltage V₄ at which the third ramp 76 starts to rise at the transition from the first phase (a) to the second phase (b) may be predetermined or specified based on analog dynamic range, stability, and/or polarity of the analog control loop. The voltage V₅ at which the fourth ramp 77 starts to fall at the transition from the first phase (a) to the second phase (b) may be predetermined or specified based on analog dynamic range, stability, and/or polarity of the analog control loop. In an example, the third and fourth ramp 76, 77 may be symmetrical.

In an example, the controller 30b is configured to control the plurality of switches to transition from the second phase (b) to the third phase (c). The second phase (b) is operated for the duration tb as described with reference to FIG. 4. Once the voltage of the third ramp 76 rises above (or equal to) the integrator signal, the output of the second ramp comparator 50b changes resulting in a phase transition signal to control the plurality of switches to transition from the second phase (b) to the third phase (c), as shown in FIG. 12. Once the voltage of the fourth ramp 77 falls below (or equal to) the integrator signal, the output of the first ramp comparator 50a changes resulting in a phase transition signal to control the plurality of switches to transition from the second phase (b) to the third phase (c), as shown in FIG. 12. Therefore, a change in output at either of the first ramp comparator 50a or the second ramp comparator 50b may result in a phase transition signal to control the plurality of switches to transition from the second phase (b) to the third phase (c).

The controller 30b is further configured to control the plurality of switches to end the third phase (c) in response to determining that the current is substantially equal to the base current I_ADAPT level 55, as shown in FIG. 12.

In an example, if there is an imbalance during the third phase (c) and the POS output node is served, then the controller 30c is further configured to control the plurality of switches to end the third phase (c) in response to determining that the current that flows between the POS output node and ground GND is substantially equal to the base current I_ADAPT level 55. The current that flows between the POS output node and ground GND reduces until the base current I_ADAPT is reached (e.g., a zero-crossing in DCM, or non-zero level in CCM), then the plurality of switches of the power converter 10 are controlled so as to operate the power converter 10 to end the third current pulse 18, or operate in the null phase.

In an example, if there is an imbalance during the third phase (c) and the NEG output node is served, then the controller 30c is further configured to control the plurality of switches to end the third phase (c) in response to determining that the current that flows between the NEG output node and ground GND is substantially equal to the base current I_ADAPT level 55. The current that flows between the NEG output node and ground GND reduces until the base current I_ADAPT is reached (e.g., a zero-crossing in DCM, or non-zero level in CCM), then the plurality of switches of the power converter 10 are controlled so as to operate the power converter 10 to end the third current pulse 18, or operate in the null phase.

In alternative examples, the controller 30b is configured to control the plurality of switches to end the second phase (b) in response to determining that the current is substantially equal to the base current I_ADAPT level 55. Therefore, the control block 42 may not determine a change in output at either of the first ramp comparator 50a or the second ramp comparator 50b.

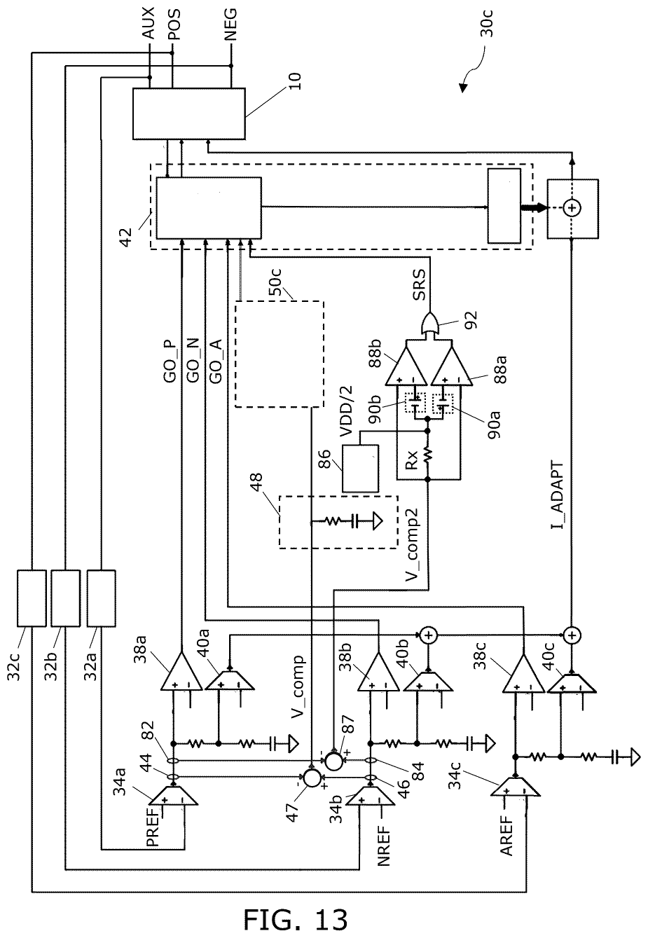

FIG. 13 shows an example of a schematic block wiring diagram of a controller 30c for performing a method described herein. The controller 30c is particularly beneficial when operated compensate for large load imbalances at one or more outputs of the power converter 10. The controller 30c is configured to control a plurality of switches of the power converter 10 to operate the power converter 10 with any mode of operation described. The controller 30c of FIG. 13 shows all of the features of the controllers 30a, 30b of FIGS. 8 and 11, in addition to additional components suitable for regulating a corresponding output voltage with a large load imbalance. The same reference numerals are used to denote the same/corresponding features in relation to FIG. 8 and will not be described in detail again below. In particular, the controller 30c comprises a block 50c which may comprise the features corresponding to the ramp comparator 50 of FIG. 8, and/or the first and second ramp comparators 50a, 50b of FIG. 11.

The controller 30c is configured to determine a load imbalance condition based on the first output voltage VPOS, the second output voltage VNEG, and an imbalance threshold. The load imbalance may be a large load imbalance which is large enough to generate problems with the analog dynamic range of charge balancing control.

When the load imbalance condition is determined the controller 30c is configured to control a plurality of switches of the power converter 10 to operate the power converter 10 to generate a standalone current pulse to serve one of: the POS output POS, or, the NEG output. In an example, the power converter 10 may generate a series of standalone current pulses serving either just the POS output or just the NEG output while the large load imbalance condition persists.

FIG. 13 shows example components to determine a load imbalance condition. Specifically, a load imbalance determination circuit comprises the first GM block 34a, the second GM block 34b, a second current subtractor circuit (comprising current sensor 82, 84 and subtractor 87), a common mode reference voltage generator 86, a resistor Rx, a first bias voltage source 90a, a second bias voltage source 90b, a first imbalance comparator 88a, a second imbalance comparator 88b, and a OR-gate 92. The load imbalance determination circuit may output a standalone request signal SRS to the control block 42. The standalone request signal SRS may be asserted to indicate a load imbalance condition requiring a standalone current pulse to be generated by the power converter 10. In an example, the current sensors 82, 84 may be implemented as a current mirror arrangement.

When no load imbalance condition is determined, i.e., a normal load condition, the controller 30c operates as described with reference to FIGS. 8 and/or 11. That is, the controller 30c operates with a mode of operation to operate the power converter 10 to generate a differential current pulse for serving two of the outputs (e.g., POS, NEG).

If the load imbalance becomes too large, then it may not be possible to balance the charges at the POS output and NEG output. Therefore, the first output voltage VPOS or the second output voltage VNEG may drift out of regulation. Standalone current pulses (i.e., current pulses which serve only one output node) may be generated by the power converter 10 to bring the first output voltage VPOS or the second output voltage VNEG back into regulation. Regulating the first output voltage VPOS and/or the second output voltage VNEG with standalone current pulses is less efficient than with differential current pulses (e.g., first, second, and third current pulses 14, 16, 18), however, may be necessary to maintain suitable regulation. It is preferable to regulate the first output voltage VPOS and/or the second output voltage VNEG with differential current pulses as soon as the load imbalance condition clears, i.e., a normal load condition.

In an example, a normal load condition may be determined after the load imbalance condition if at least one standalone pulse is provided on each of the two output nodes after having (re-)entered differential operation and the controller 30c determines that both output nodes are not under-or over-regulated. In another example, the normal load condition may be determined if the control block no longer asserts a standalone request signal SRS after re-trying the differential mode.

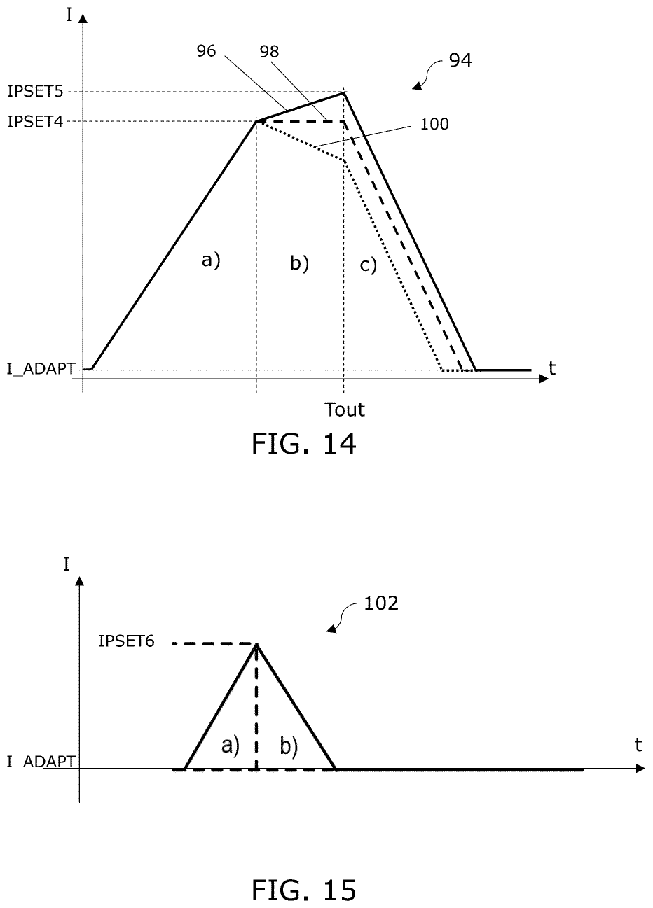

FIG. 14 shows a first standalone current pulse 94 generated by operating the power converter 10 suitable for regulating the first output voltage VPOS. Time is shown on the x-axis, and current is shown on the y-axis. The controller 30c is configured to control the plurality of switches of the power converter 10 to generate the first standalone current pulse 94. The controller 30c may operate in a fourth mode to control the plurality of switches of the power converter 10 to generate the first standalone current pulse 94.

As shown in FIG. 14, the fourth mode operates the power converter 10 to generate the first standalone current pulse 94 comprising at least two phases, a first phase (a), a second phase (b), and an optional third phase (c).

During the first phase (a) the inductor 12 of the power converter 10 is charged until a current value through the inductor 12 is equal to or greater than a fourth current threshold IPSET4. During the second phase (b) the charge of the inductor 12 is adjusted and current flows at the POS output. During the third phase (c) the inductor 12 is discharged and current flows at the POS output.

During the first phase (a) the plurality of switches are controlled to couple the second inductor node LXB of the inductor 12 to the input node IN, and couple the first inductor node LXA of the inductor 12 to ground GND such that the inductor 12 is charged by a current that flows between the input node IN and ground GND. During the first phase (a), the third switch SWIN and the fifth switch SWGB of the plurality of switches are controlled to be closed, and the other switches of the plurality of switches (e.g., SWPOS, SWNEG, SWGA, and, if present, SWAUX) are controlled to be open.

The plurality of switches of the power converter 10 are controlled so as to operate the power converter 10 to transition from the first phase (a) to the second phase (b) in response to a comparison of: the current that flows between the input node IN and ground GND; and the fourth current threshold IPSET4. As shown in FIG. 14, the current that flows between the input node IN and ground GND raises until the fourth current threshold IPSET4 is reached, then the plurality of switches of the power converter 10 are controlled to operate the power converter 10 in accordance with the second phase (b).

During the second phase (b) the plurality of switches are controlled to couple the second inductor node LXB of the inductor 12 to the input node IN, and couple the second terminal of the inductor to the POS output node such that the inductor is adjusted by a current that flows between the input node IN and POS output node. During the second phase (b), the third switch SWIN and the first switch SWPOS of the plurality of switches are controlled to be closed, and the other switches of the plurality of switches (e.g., SWNEG, SWGA, SWGB, and, if present, SWAUX) are controlled to be open.

In an example, the input voltage VIN is greater than the magnitude of the first output voltage VPOS, the current further increases as shown by solid line 96. That is, in the second phase (b) of the first standalone current pulse 94 the plurality of switches are controlled to couple the second inductor node LXB of the inductor 12 to the input node IN, and couple the second terminal of the inductor to the POS output node such that the inductor is charged by a current that flows between the input node IN and the POS output node.

When operating in the fourth mode to generate the first standalone current pulse 94, the plurality of switches of the power converter 10 are controlled so as to operate the power converter 10 to transition from the second phase (b) to the third phase (c) in response to a comparison of: the current that flows between the input node IN and the POS output node; and a fifth current threshold IPSET5. As shown in FIG. 14 and solid line 96, the current that flows between the input node IN and the POS output node raises until the fifth current threshold IPSET5 is reached, then the plurality of switches of the power converter 10 are controlled to operate the power converter 10 in accordance with the third phase (c). In addition, or alternatively, the start of the second phase (b) may start a timeout timer with predetermined or specified duration (i.e., a predetermined or specified timeout duration). If the current increases during the second phase (b) but does not reach the fifth current threshold IPSET5 before the timeout timer expires, then the plurality of switches of the power converter 10 are controlled so as to operate the power converter 10 to transition from the second phase (b) to the third phase (c).

In an example, the input voltage VIN is similar to the magnitude of the first output voltage VPOS, the current remains substantially unchanged as shown by dashed line 98. The start of the second phase (b) may start the timeout timer with predetermined or specified duration. As shown in FIG. 14 and dashed line 98, once the timeout timer expires (at time Tout), then the plurality of switches of the power converter 10 are controlled so as to operate the power converter 10 to transition from the second phase (b) to the third phase (c).

In an example, the input voltage VIN is less than the magnitude of the first output voltage VPOS, the current decreases as shown by dotted line 100. That is, in the second phase (b) of the first standalone current pulse 94 the plurality of switches are controlled to couple the second inductor node LXB of the inductor 12 to the input node IN, and couple the second terminal of the inductor to the POS output node such that the inductor is discharged by a current that flows between the input node IN and the POS output node.

When operating in the fourth mode to generate the first standalone current pulse 94, the plurality of switches of the power converter 10 are controlled so as to operate the power converter 10 to transition from the second phase (b) to the third phase (c) in response the timeout timer. The start of the second phase (b) may start the timeout timer with predetermined or specified duration. As shown in FIG. 14 and dotted line 100, once the timeout timer expires (at time Tout), then the plurality of switches of the power converter 10 are controlled so as to operate the power converter 10 to transition from the second phase (b) to the third phase (c). In addition or alternatively, the plurality of switches of the power converter 10 are controlled so as to operate the power converter 10 to transition from the second phase (b) to the third phase (c) in response to a comparison of: the current that flows between the input node IN and the POS output node; and the base current I_ADAPT. The current that flows between the input node IN and the POS output node reduces until the base current I_ADAPT is reached (e.g., a zero-crossing in DCM, or non-zero level in CCM), then the plurality of switches of the power converter 10 are controlled so as to operate the power converter 10 to end the first standalone current pulse 94, or operate in the null phase.

During the optional third phase (c) the plurality of switches are controlled to couple the second inductor node LXB of the inductor 12 to the ground GND and couple the first inductor node LXA to the POS output node such that the inductor 12 is discharged by a current that flows between the POS output node and ground GND. During the third phase (c), the first switch SWPOS and the fourth switch SWGA of the plurality of switches are controlled to be closed, and the other switches of the plurality of switches (e.g., SWNEG, SWIN, SWGB, and, if present, SWAUX are controlled to be open.

In the fourth mode, once the third phase (c) ends the power converter 10 may be operated with the first phase (a) of the first current pulse 14 or with the null phase.

In an example, when operating with the fourth mode, the fourth current threshold IPSET4 and/or fifth current threshold IPSET5 are not dependent on the input voltage at input IN. Advantageously, this allows for improved efficiency. The fourth current threshold IPSET4 and/or the fifth current threshold IPSET5 can be predetermined or specified to provide efficient power conversion and voltage output ripple. The fourth current threshold IPSET4 and/or the fifth current threshold IPSET5 may be predetermined or specified through experimentation for to a particular use case or application. The fourth current threshold IPSET4 and/or the fifth current threshold IPSET5 may be relative to the base current I_ADAPT value. When the power converter 10 is operating in DCM, the base current I_ADAPT value may be zero amps. When the power converter 10 is operating in CCM, the base current I_ADAPT value may be non-zero, and determined prior to the first phase (a), e.g., immediately prior.

The controller 30c may operate in a fifth mode to control the plurality of switches of the power converter 10 to generate a second standalone current pulse for serving a third output voltage (VAUX) at the AUX output node. The operation of the fifth mode corresponds to the operation of the fourth mode and differs in so far that the AUX output node is served in place of the POS output node. Specifically, in a first phase (a) of the second standalone current pulse, the plurality of switches are controlled to couple the second inductor node LXB of the inductor 12 to the input node IN, and couple the first inductor node LXA of the inductor 12 to ground GND such that the inductor 12 is charged by a current that flows between the input node IN and ground GND. In a second phase (b) of the second standalone current pulse, the plurality of switches are controlled to couple the second inductor node LXB of the inductor 12 to the input node IN, and couple the second terminal of the inductor to the AUX output node such that the inductor is adjusted by a current that flows between the input node IN and AUX output node. In an optional third phase (c) of the second standalone current pulse, the plurality of switches are controlled to couple the second inductor node LXB of the inductor 12 to the ground GND and couple the first inductor node LXA to the AUX output node such that the inductor 12 is discharged by a current that flows between the AUX output node and ground GND. The operation of the fifth mode can therefore be understood with reference to FIG. 14 and will not be described in detail.

FIG. 15 shows a third standalone current pulse 102 generated by operating the power converter 10 suitable for regulating the second output voltage VNEG. Time is shown on the x-axis, and current is shown on the y-axis. The controller 30c is configured to control the plurality of switches of the power converter 10 to generate the third standalone current pulse 102. The controller 30c may operate in a sixth mode to control the plurality of switches of the power converter 10 to generate the third standalone current pulse 102.

As shown in FIG. 15, the sixth mode operates the power converter 10 to generate the third standalone current pulse 102 comprising two phases, a first phase (a), and a second phase (b).

During the first phase (a) the inductor 12 of the power converter 10 is charged until a current value through the inductor 12 is equal to or greater than a sixth current threshold IPSET6. During the second phase (b) the charge of the inductor 12 is discharged and current flows at the NEG output.

During the first phase (a) the plurality of switches are controlled to couple the second inductor node LXB of the inductor 12 to the input node IN, and couple the first inductor node LXA of the inductor 12 to ground GND such that the inductor 12 is charged by a current that flows between the input node IN and ground GND. During the first phase (a), the third switch SWIN and the fifth switch SWGB of the plurality of switches are controlled to be closed, and the other switches of the plurality of switches (e.g., SWPOS, SWNEG, SWGA, and, if present, SWAUX) are controlled to be open.

During the second phase (b) the plurality of switches are controlled to couple the second inductor node LXB of the inductor 12 to the NEG output node and couple the first inductor node LXA to ground GND such that the inductor 12 is discharged by a current that flows between the NEG output node and ground GND. During the second phase (b), the second switch SWNEG and the fifth switch SWGB of the plurality of switches are controlled to be closed, and the other switches of the plurality of switches (e.g., SWPOS, SWIN, SWGA, and, if present, SWAUX are controlled to be open.

In an example, during the second phase (b), the current decreases as shown by third standalone current pulse 102. The plurality of switches of the power converter 10 are controlled so as to operate the power converter 10 to end the second phase (b) in response to a comparison of: the current that flows between the NEG output node and ground GND; and the base current I_ADAPT. The current that flows between the NEG output node and ground GND reduces until the base current I_ADAPT is reached (e.g., a zero-crossing in DCM, or non-zero level in CCM), then the plurality of switches of the power converter 10 are controlled so as to operate the power converter 10 to end the third standalone current pulse 102, or operate in the null phase.

In an example, the sixth current threshold IPSET6 is relative to the base current I_ADAPT value. When the power converter 10 is operating in DCM, the base current I_ADAPT value may be zero amps. When the power converter 10 is operating in CCM, the base current I_ADAPT value may be non-zero, and determined prior to the first phase (a), e.g., immediately prior.

Returning to FIG. 13, and specifically the load imbalance determination circuit, the controller 30c is configured to compare a first signal (e.g., from the first feedback buffer 32a) corresponding to the first output voltage VPOS, to the first regulation voltage level PREF to generate a first comparison signal. The controller 30c is further configured to compare a second signal (e.g., from the second feedback buffer 32b) corresponding to the second output voltage VNEG, to the second regulation voltage level NREF to generate a second comparison signal. Specifically, as shown in FIG. 13 these steps may be performed by the first GM block 34a, the second GM block 34b.

The purpose of the load imbalance determination circuit is to determine how much one of the output voltages (e.g., VPOS, or VNEG) may deviate off regulation while the controller 30c operates with one of the differential modes (i.e., the first, second, and third modes) before entering one of the standalone modes (i.e., fourth, fifth, or sixth modes). Once the load imbalance determination circuit outputs a standalone request signal SRS then, the controller 30c may enter one of the standalone modes (i.e., fourth, fifth, or sixth modes). The controller 30c determines which output to serve based on receiving one of the first request GO_P, the second request GO_N, and the third request GO_A. That is, in an example, the controller 30c may receive the standalone request signal SRS and the first request GO_P, indicating that the controller 30c should enter the fourth mode (see FIG. 14) to correct an imbalance. In another example, the controller 30c may receive the standalone request signal SRS and the second request GO_N, indicating that the controller 30c should enter the sixth mode (see FIG. 15) to correct an imbalance.

The load imbalance condition is determined when the difference of the first and second comparison signals is greater than an upper threshold or less than a lower threshold. Specifically, a current subtractor circuit (comprising current sensor 82, 84, and subtractor 87) is arranged to receive the first comparison signal and the second comparison signal to generate an imbalance signal VCOMP2. In addition, two comparators (i.e., the first imbalance comparator 88a, and second imbalance comparator 88b) are configured to determine the load imbalance condition by outputting the standalone request signal SRS. The two comparators configured to: compare the imbalance signal VCOMP2 to the upper threshold and the lower threshold. Specifically, the first imbalance comparator 88a is configured to compare the imbalance signal VCOMP2 to the lower threshold. The second imbalance comparator 88b is configured to compare the imbalance signal VCOMP2 to the upper threshold.

The upper threshold and lower threshold are predetermined or specified. The upper threshold and lower threshold are based on the common mode reference voltage generator 86. The common mode reference voltage generator 86 outputs a voltage at common mode voltage reference VDD/2. The lower threshold is based on the voltage of the common mode voltage reference VDD/2 and the voltage of the first bias voltage source 90a. The upper threshold is based on the voltage of the common mode voltage reference VDD/2 and the voltage of the second bias voltage source 90b. The voltage of the common mode voltage reference may be half of the internal supply voltage VDD/2 used for control. The upper and lower thresholds may be symmetrical about the common mode voltage reference. The imbalance threshold may be one or both of the upper and lower thresholds.

The first and second imbalance comparators 88a, 88b are arranged in parallel. In addition, the standalone request signal SRS is output when either one of the first and second imbalance comparators 88a, 88b asserts an output (indicating that the one of the upper or lower thresholds is reached). That is, the outputs of the first and second imbalance comparators 88a, 88b are OR-ed, i.e. the controller 30c is configured to operate with one of the standalone modes when either imbalance signal VCOMP2 goes above the upper threshold or when the imbalance signal VCOMP2 goes below the lower threshold.

In an example, the resistor RX is coupled to the common mode reference voltage generator 86 which also the upper/lower threshold are referred (e.g. half of the internal supplies used for control). The imbalance signal VCOMP2 exceeding the upper threshold means that the difference between the first and second output voltages VPOS, VNEG has exceeded an amount equal to the product of: the difference between the voltage of the common mode voltage reference and the voltage of the second bias voltage source 90b; and the voltage drop over the resistor Rx (equivalent to the resistance of Rx*the current output from subtractor 87).

Advantageously, precise control of the deviation of one of the POS and NEG output nodes (with respect to the corresponding regulation voltage VREF, NREF) before detecting the large load imbalance condition and can keep any error under control. That is, when a large load imbalance appears and the controller 30c is operating with the differential current pulse control (i.e., one of the first, second, or third modes, that aim to balance the charges), only one of the output voltages (e.g., VPOS, or VNEG) can go off regulation while the other (e.g., VNEG, or VPOS) will remain regulated. Therefore, the purpose of the load imbalance determination circuit is to determine how much the one of the output voltages (e.g., VPOS, or VNEG) may deviate off regulation before entering one of the standalone modes (i.e., fourth, fifth, or sixth modes).

In an example, the controller is configured to determine a normal load condition based on the first output voltage VPOS, the second output voltage VNEG, and a second imbalance threshold. In the example of FIG. 13, the second imbalance threshold is the imbalance threshold (i.e., may be one or both of the upper and lower thresholds). In an alternative example, the second imbalance threshold may be different to the imbalance threshold. When the normal load condition is determined the controller 30c is configured to control the plurality of switches of the power converter 10 to operate the power converter 10 with a differential current pulse to serve both the POS output node and the NEG output node (i.e., the controller 30c operates in the first, second, or third mode).

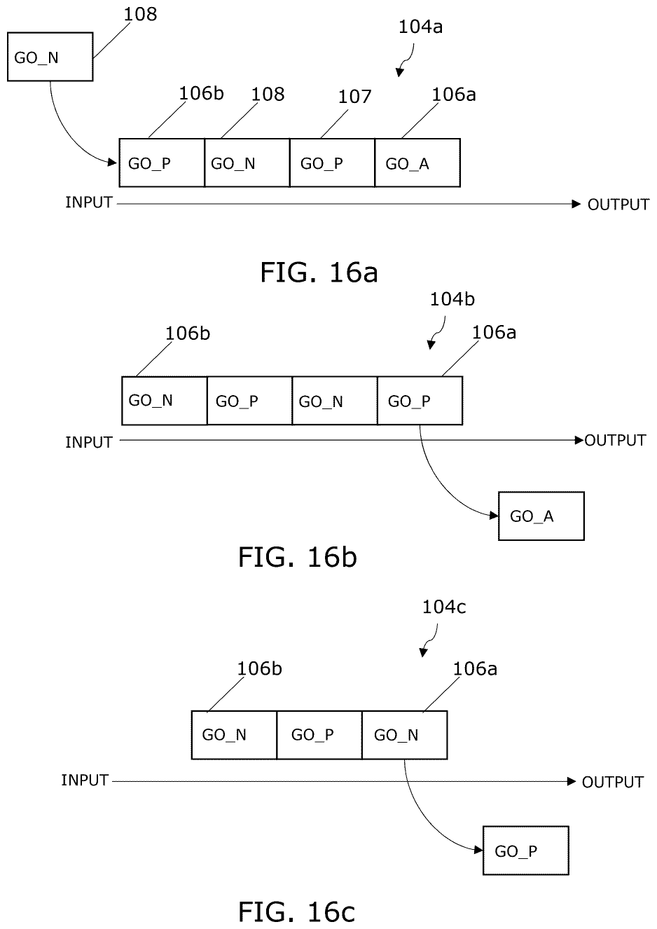

FIGS. 16a, 16b, and 16c show an example of a first-in-first-out (FIFO) algorithm suitable for use with any controller 30, 30a, 30b, 30c described herein. The FIFO algorithm may be performed by the control block 42. The FIFO algorithm may receive one or more GO_P request, one or more GO_N request, and/or one or more GO_A request and operate the controller in a mode of operation (e.g., the first, second, third, fourth, fifth, and/or sixth mode).

In an example, when a GO_P request is actioned by the controller, then the controller operates to serve the POS output node. When a GO_N request is actioned by the controller, then the controller operates to serve the NEG output node. When a GO_A request is actioned by the controller, then the controller operates to serve the AUX output node.

FIG. 16a shows a queue of requests 104a for operating the power converter 10. The queue of requests 104a is a FIFO queue. The first request 106a received by the control block 42 is a first GO_A request. The latest request 106b received by the control block 42 is a first GO_P request.

FIG. 16a shows a new request 108 (e.g., a first GO_N request) being received by the control block 42 and to be added to the queue of requests 104a. The second request 107 received by the control block 42 is a second GO_P request. The third request 108 received by the control block 42 is a second GO_N request.

FIG. 16b shows an updated queue of requests 104b. The updated queue of requests 104b now comprises the first GO_N request (previously the new request 108) as the latest request 106b. The first GO_A request (previously at the first request 106a) is actioned by the controller and removed from the updated queue of requests 104b. The second GO_P request is promoted to the first request 106a of the updated queue of requests 104b.

FIG. 16c shows a further updated queue of requests 104c. No new request is received at the control block 42, and so the further updated queue of requests 104c comprises the first GO_N request as the latest request 106b. The second GO_P request (previously at the first request 106a of the updated que of requests 104b) is actioned by the controller and removed from the further updated queue of requests 104c. The second GO_N request is promoted to the first request 106a of the further updated queue of requests 104c.

For each request actioned by the controller, the controller may control the plurality of switches of the power converter 10 to operate the power converter 10 to generate a corresponding current pulse.

Therefore, in an example, the controller may generate a queue of requests for operating the power converter 10. Each request of the queue of requests 104a, 104b, 104c corresponds to one of the POS output node, NEG output node, and optionally, AUX output node, for serving a respective one of the POS output node, the NEG output node, and optionally, the AUX output node. The controller may control a plurality of switches of the power converter 10 to operate the power converter 10 to generate a new current pulse based on a first request of the queue of requests.

In an example, the new current pulse may comprise one of the first current pulse 14, the second current pulse 16, the third current pulse 18, the first standalone current pulse 94, the second standalone current pulse, or the third standalone current pulse 102.

If the new current pulse is one of the first, second, or third current pulses 14, 16, 18 (and based on the GO_P or GO_N requests), then during the new current pulse, current flows at the POS output node for serving the POS output node, and current flows at the NEG output node for serving the NEG output node. Therefore, the new current pulse is a differential current pulse suitable for regulating the first output voltage VPOS based on the first predetermined or specified voltage level PREF; and, the second output voltage VNEG based on the second predetermined or specified voltage level NREF.

In an example, if the new current pulse is the first standalone current pulse 94 (and based on the GO_P request), then during the new current pulse, current flows at the POS output node for serving the POS output node. The first standalone current pulse 94 regulates the first output voltage VPOS based on the first predetermined or specified voltage level PREF.

In an example, if the new current pulse is the second standalone current pulse (and based on the GO_A request), then during the new current pulse, current flows at the AUX output node for serving the AUX output node. The second standalone current pulse regulates the third output voltage VAUX based on the third predetermined or specified voltage level AREF.

In an example, if the new current pulse is the third standalone current pulse 102 (and based on the GO_N request), then during the new current pulse, current flows at the NEG output node for serving the NEG output node. The third standalone current pulse 102 regulates the second output voltage VNEG based on the second predetermined or specified voltage level NREF.

The controller may control the plurality of switches of the power converter 10 to operate the power converter 10 to generate one of a plurality of current pulses based on the second request of the queue of requests, after the power converter 10 is operated based on the first request.

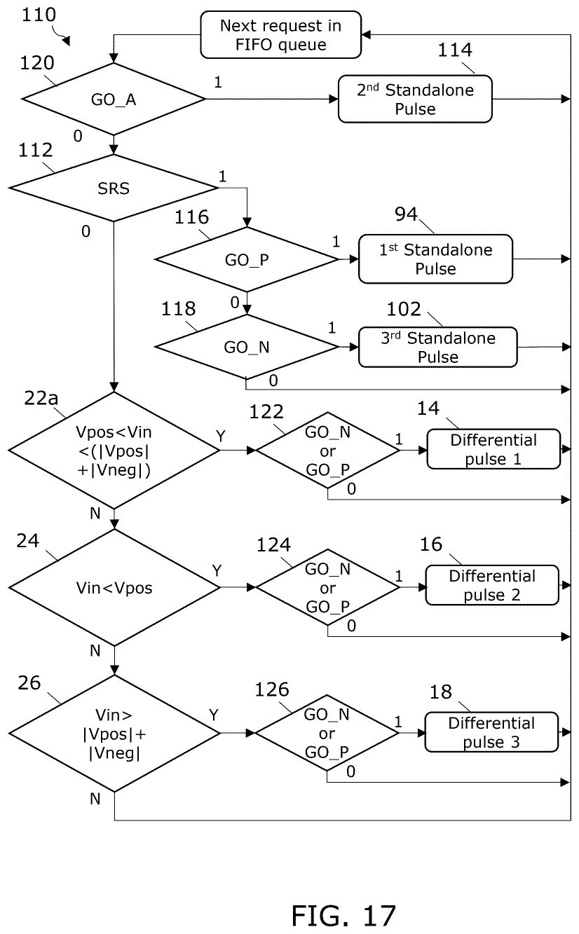

FIG. 17 shows an example flow diagram 110 for controlling the power converter 10 for performing a method described herein. The flow diagram 110 of FIG. 17 is suitable for regulating multiple output voltages based on receiving a respective output voltage feedback and requests from a queue of requests (e.g., as shown in FIGS. 16a, 16b, 16c). The flow diagram 20 and/or flow diagram 110 of FIG. 17 may be implemented by the controller 30, 30a, 30b, 30c.

FIG. 17 shows that when a load imbalance condition is determined via SRS decision block 112 (e.g., SRS signal asserts a logical ‘1’), then the controller may operate to generate the first standalone current pulse 94, second standalone current pulse 114, or third standalone current pulse 102 (e.g., based on the first request in a FIFO queue, e.g., GO_P, GO_N, GO_A). The decision blocks 116, 118, 120, 122, 124, 126 each read which request is the first request in the FIFO queue and make a decision accordingly. For example, if the first request is a GO_P request, then decision blocks 116, 122, 124, 126 generate a logical ‘1’ output.

In an example, the SRS decision block 112 determines a load imbalance condition based on the first output voltage VPOS, the second output voltage VNEG, and an imbalance threshold (e.g., lower threshold, and/or upper threshold of FIG. 13). When the load imbalance condition is determined (via SRS decision block 112) and a request is at the front of the queue of requests (e.g., GO_P, GO_N, or GO_A), control the plurality of switches of power converter 10 to operate the power converter 10 to generate a standalone current pulse (e.g., first standalone current pulse 94, third standalone current pulse 102, or second standalone current pulse 114) based on the request (e.g., GO_P, GO_N, or GO_A, respectively).

FIG. 17 also shows that when a load imbalance condition is not determined via SRS decision block 112 (e.g., SRS signal asserts a logical ‘0’), then the controller may operate to generate the second standalone current pulse 114, first current pulse 14, second current pulse 16, or third current pulse 18 (e.g., based on one request GO_P, GO_N, GO_A). It is advantageous to regulate the first and second output voltages VPOS and VNEG with a differential current pulse (e.g., first current pulse 14, second current pulse 16, or third current pulse 18, depending on the input voltage VIN). It is also beneficial to also regulate the third output voltage VAUX, when requested, with a standalone current pulse (e.g., the second standalone current pulse 114).

In an example, the SRS decision block 112 determines a normal condition (e.g., SRS signal asserts a logical ‘0’) based on the first output voltage VPOS, the second output voltage VNEG, and a second imbalance threshold (e.g., lower threshold, and/or upper threshold of FIG. 13). When the normal condition is determined (via SRS decision block 112) and a request is at the front of the queue of requests (e.g., GO_P, or GO_N), control the plurality of switches of power converter 10 to operate the power converter 10 to generate a differential current pulse (e.g., first current pulse 14, second current pulse 16, or third current pulse 18) based on the request (e.g., GO_P, and/or GO_N).

It should be understood that at any given moment there may be more than one request received by in the control block 42 (i.e., more than one request in the queue) and that the control block 42 will perform the operations represented in FIG. 17 based on the first request in the queue, in accordance with FIFO principles (i.e., the “next request in FIFO queue”, as shown at the top of FIG. 17). This may be achieved in any suitable way. For example, the control block 42 may comprise FIFO logic that processes the received signals GO_P, GO_N and GO_A so that if more than one of the signals is a “1”, internally to the control block 42 the first signal in the queue remains at “1” and the others are changed to “0” for the purpose of the processes shown in FIG. 17. Once that signal has been dealt with, the next signal in the queue is no longer internally changed to “0” and instead remains at “1” for the purpose of the processes shown in FIG. 17, etc.

The DC-DC power converters described herein may be used for may purposes, where a regulated supply of DC power is desired. For example, they may be used in electronic devices (such as mobile electronic devices, for example smart phones, tablet computers, laptop computers, etc.) to convert input DC power, which may be variable in size depending on the source of DC power, to a controlled DC power level for powering electronic circuits within the device, for example, a device display(s) (e.g., AMOLED displays). For example, the first output node and/or second output of the DC-DC power converter may be coupled to a display of the electronic device, for use in controlling at least one characteristic of the display, such as pixel-level colour control and/or display output power for brightness.

### General

Although the power converter 10 is shown with one AUX output node, in other examples, the power converter may not comprise any additional output nodes (other than POS output node, and NEG output node), or may comprise two or more AUX output nodes regulated to different voltages. The control of each additional AUX output nodes may be controlled similarly to the AUX output nodes described herein.

Although the controller 30, 30a, 30b, 30c is configured to control the power converter 10. In other examples, the controller 30, 30a, 30b, 30c may be configured to control other power converters to generate one or more of the first current pulse 14, the second current pulse 16, the third current pulse 18, the first standalone current pulse 94, the second standalone current pulse, or the third standalone current pulse 102.

Each block of the Figures is shown and defined for explanatory purposes only, it would be well understood that the algorithm or function which each block represents may be implemented in a plurality of other ways so long as the functionality as described is present. For example, blocks may be combined and implemented as part of a circuit arrangement, on a single integrated circuit, processor, or computer, or implemented by a plurality of circuit arrangements, integrated circuits, processors, and/or computers.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.”

The words “coupled” or “connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. Moreover, in the following claims, the terms “initial”, “first”, “second”, “third”, “fourth”, etc. are used merely as labels, and are not intended to impose numerical requirements on their objects. Methods examples described herein can be machine or computer-implemented at least in part.

It is to be understood that one or more features from one or more of the above-described embodiments may be combined with one or more features of one or more other ones of the above-described embodiments, so as to form further embodiments which are within the scope of the appended claims.

### NUMBERED CLAUSES

By way of non-limiting example, some aspects of the disclosure are set out in the following numbered clauses.

### First Set

1. A controller for controlling a DC-DC power converter, the controller arranged to couple to a first output (POS) and a second output (NEG) of a DC-DC power converter, and configured to: receive the first output voltage (VPOS) from the first output (POS); receive the second output voltage (VNEG) at the second output (NEG); control a plurality of switches of a DC-DC power converter to operate the DC-DC power converter with a first mode to: regulate the first output voltage (VPOS) based on the first predetermined or specified voltage level; and, regulate the second output voltage (VNEG) based on the second predetermined or specified voltage level, wherein the first mode comprises: a first phase during which an inductor of the DC-DC power converter is charged; a second phase during which the charge of the inductor is adjusted; and a third phase during which the inductor is discharged, wherein during at least one of the phases, current flows at the first output, wherein during at least one of the phases, current flows at the second output, and wherein the second phase is operated for a duration based on the first output voltage (VPOS) and the second output voltage (VNEG).
2. The controller of clause 1, wherein the controller is configured to: compare a first signal corresponding to the first output voltage (VPOS), to a first regulation voltage level to generate a first comparison signal; compare a second signal corresponding to the second output voltage (VNEG), to a second regulation voltage level to generate a second comparison signal; generate an integrator signal based on integrating the difference of the first comparison signal and the second comparison signal; and compare the integrator signal to a ramp signal, wherein the duration of the second phase is based on the comparison between the integrator signal and the ramp signal.
3. The controller of clause 2, wherein the controller comprises: a first Operational Transconductance amplifier (OTA) arranged receive the first signal and the first regulation voltage level to generate the first comparison signal, wherein the first comparison signal is a current; a second OTA arranged receive the second signal and the second regulation voltage level to generate the second comparison signal, wherein the second comparison signal is a current; a current subtractor circuit arranged to receive the first comparison signal and the second comparison signal, wherein the current subtractor circuit comprises an output; an RC circuit configured to couple to the output of the current subtractor circuit to a voltage reference (GND) via a series resistor and capacitor; and a comparator comprising an input coupled to the output of the current subtractor circuit, and configured to: compare the integrator signal to the ramp signal; and, generate a phase transition signal to operate the DC-DC power converter to transition from the second phase to the third phase.
4. The controller of any preceding clause, wherein the controller is configured to control the plurality of switches to transition from the first phase to the second phase in response to a comparison of: the current that flows between the input (IN) and the first output (POS) or a reference node (GND); and a current threshold.
5. The controller of any preceding clause, wherein the controller is configured to control the plurality of switches to transition from the second phase to the third phase, wherein the second phase is operated for a duration so as to substantially balance a first charge at the first output (POS) and a second charge at the second output (NEG) during the first mode.
6. The controller of any preceding clause, wherein the controller is further configured to: control the plurality of switches to end the third phase in response to determining that the current is substantially equal to a base current level, wherein the base current level is substantially equal to a current level immediately prior to the DC-DC power converter operating in the first phase of the first mode.
7. The controller of any preceding clause, the DC_DC power converter comprising: a first switch (SWPOS) of the plurality of switches coupled between the first output (POS) and a first node (LXB); a second switch (SWNEG) of the plurality of switches coupled between the second output (NEG) and a second node (LXA); a third switch (SWIN) of the plurality of switches coupled between an input (IN) and the second node (LXA); a fourth switch (SWGA) of the plurality of switches coupled between the second node (LXA) and a reference node (GND); a fifth switch (SWGB) of the plurality of switches coupled between the first node (LXB) and the reference node (GND); and an inductor coupled between the first node (LXA) and the second node (LXB).
8. The controller of any preceding clause, wherein during the first phase, the first (SWPOS) and third (SWIN) switches of the plurality of switches are controlled to be closed, and the second, fourth, and fifth switches of the plurality of switches are controlled to be open; wherein during the second phase, the third (SWIN) and fifth (SWGB) switches of the plurality of switches are controlled to be closed, and the first, second, and fourth switches of the plurality of switches are controlled to be open; and wherein during the third phase, the second (SWNEG) and fifth (SWGB) switches of the plurality of switches are controlled to be closed, and the first, third, and fourth switches of the plurality of switches are controlled to be open.
9. The controller of any preceding clause, wherein during the first phase, the third (SWIN) and fifth (SWGB) switches of the plurality of switches are controlled to be closed, and the first, second, and fourth switches of the plurality of switches are controlled to be open; wherein during the second phase, the second (SWNEG) and fifth (SWGB) switches of the plurality of switches are controlled to be closed, and the first, third, and fourth switches of the plurality of switches are controlled to be open; and wherein during the third phase, the first (SWPOS) and third (SWIN) switches of the plurality of switches are controlled to be closed, and the second, fourth, and fifth switches of the plurality of switches are controlled to be open.
10. The controller of any preceding clause, wherein during the first phase, the third (SWIN) and fifth (SWGB) switches of the plurality of switches are controlled to be closed, and the first, second, and fourth switches of the plurality of switches are controlled to be open; wherein during the second phase, the first (SWPOS) and second (SWNEG) switches of the plurality of switches are controlled to be closed, and the third, fourth, and fifth switches of the plurality of switches are controlled to be open; and wherein during the third phase: the first (SWPOS) and fourth (SWGA) switches of the plurality of switches are controlled to be closed, and the second, third, and fifth switches of the plurality of switches are controlled to be open; or the second (SWNEG) and fifth (SWGB) switches of the plurality of switches are controlled to be closed, and the first, third, and fourth switches of the plurality of switches are controlled to be open.
11. The controller of any preceding clause, wherein the controller is further configured to control a plurality of switches of a DC-DC power converter to operate the DC-DC power converter with a null phase before the first phase, wherein during the null phase each terminal of the inductor is coupled to a reference voltage (GND).
12. The controller of any preceding clause, wherein the controller is configured to control the plurality of switches of a DC-DC power converter to operate the DC-DC power converter with a first mode in response to receiving a first request (GO_N/GO_P), wherein the first request is generated based on: one of the first output voltage (VPOS) and the second output voltage (VNEG); and, a request threshold.
13. The controller of any preceding clause, wherein the controller is configured to control the plurality of switches of a DC-DC power converter to generate a differential current pulse, wherein the differential current pulse is generated by controlling the plurality of switches of a DC-DC power converter to operate the DC-DC power converter with the first phase, the second phase, and the third phase of the first mode.
14. The controller of any one of clauses 12 or 13, wherein the controller configured to: integrate a comparison between the first output voltage (VPOS) to the first predetermined or specified voltage level to generate a first integrated signal; and compare the first integrated signal to a first regulation reference level to generate the first request (GO_P); or integrate a comparison between the second output voltage (VNEG) to the second predetermined or specified voltage level to generate a second integrated signal; and compare the second integrated signal to a second regulation reference level to generate the first request (GO_N).
15. A DC-DC power converter comprising: a first output (POS); a second output (NEG); an inductor coupled to the first output (POS) and the second output (NEG); a plurality of switches; and a controller coupled to the first output (POS) and the second output (NEG), and configured to: receive a first output voltage (VPOS) from the first output (POS); receive a second output voltage (VNEG) at the second output (NEG); control the plurality of switches of the DC-DC power converter to operate the DC-DC power converter with a first mode to: regulate the first output voltage (VPOS) based on a first predetermined or specified voltage level; and, regulate the second output voltage (VNEG) based on a second predetermined or specified voltage level, wherein the first mode comprises: a first phase during which the inductor is charged; a second phase during which the charge of the inductor is adjusted; and a third phase during which the inductor is discharged, wherein during at least one of the phases, current flows at the first output (POS), and wherein during at least one of the phases, current flows at the second output (NEG), and wherein the second phase is operated for a duration based on the first output voltage (VPOS) and the second output voltage (VNEG).
16. The DC-DC power converter of clause 15, further comprising: a first switch (SWPOS) of the plurality of switches coupled between the first output (POS) and a first node (LXB); a second switch (SWNEG) of the plurality of switches coupled between the second output (NEG) and a second node (LXA); a third switch (SWIN) of the plurality of switches coupled between an input (IN) and the second node (LXA); a fourth switch (SWGA) of the plurality of switches coupled between the second node (LXA) and a reference node (GND); a fifth switch (SWGB) of the plurality of switches coupled between the first node (LXB) and the reference node (GND); and, wherein the inductor is coupled between the first node (LXA) and the second node (LXB).
17. The DC-DC power converter of clause 16, wherein the controller is configured such that, during the first phase, the first (SWPOS) and third (SWIN) switches of the plurality of switches are controlled to be closed, and the second, fourth, and fifth switches of the plurality of switches are controlled to be open; wherein during the second phase, the third (SWIN) and fifth (SWGB) switches of the plurality of switches are controlled to be closed, and the first, second, and fourth switches of the plurality of switches are controlled to be open; and, wherein during the third phase, the second (SWNEG) and fifth (SWGB) switches of the plurality of switches are controlled to be closed, and the first, third, and fourth switches of the plurality of switches are controlled to be open.
18. The DC-DC power converter of clause 16, wherein the controller is configured such that during the first phase, the third (SWIN) and fifth (SWGB) switches of the plurality of switches are controlled to be closed, and the first, second, and fourth switches of the plurality of switches are controlled to be open; wherein during the second phase, the second (SWNEG) and fifth (SWGB) switches of the plurality of switches are controlled to be closed, and the first, third, and fourth switches of the plurality of switches are controlled to be open; and, wherein during the third phase, the first (SWPOS) and third (SWIN) switches of the plurality of switches are controlled to be closed, and the second, fourth, and fifth switches of the plurality of switches are controlled to be open.
19. The DC-DC power converter of clause 16, wherein the controller is configured such that during the first phase, the third (SWIN) and fifth (SWGB) switches of the plurality of switches are controlled to be closed, and the first, second, and fourth switches of the plurality of switches are controlled to be open; wherein during the second phase, the first (SWPOS) and second (SWNEG) switches of the plurality of switches are controlled to be closed, and the third, fourth, and fifth switches of the plurality of switches are controlled to be open; and, wherein during the third phase: the first (SWPOS) and fourth (SWGA) switches of the plurality of switches are controlled to be closed, and the second, third, and fifth switches of the plurality of switches are controlled to be open; or, the second (SWNEG) and fifth (SWGB) switches of the plurality of switches are controlled to be closed, and the first, third, and fourth switches of the plurality of switches are controlled to be open.
20. An electronic device (such as a smart phone or a smart watch) comprising the DC-DC power converter of any of clauses 16 to 19.
21. The electronic device of clause 20, further comprising a display coupled to the first output node and/or second output of the DC-DC power converter, such that at least one characteristic of the display (such as display power for brightness and/or pixel-level colour control) is controllable using the DC-DC power converter.
22. A method for controlling a DC-DC power converter, the method comprising: controlling a plurality of switches of the DC-DC power converter to operate the DC-DC power converter with a first mode to: regulate a first output voltage (VPOS) at a first output (POS), based on a first predetermined or specified voltage level; and, regulate a second output voltage (VNEG) at a second output (NEG), based on a second predetermined or specified voltage level, wherein the first mode comprises: a first phase during which an inductor of the DC-DC power converter is charged; a second phase during which the charge of the inductor is adjusted; and a third phase during which the inductor is discharged, wherein during at least one of the phases, current flows at the first output (POS), and wherein during at least one of the phases, current flows at the second output (NEG), and wherein the second phase is operated for a duration based on the first output voltage (VPOS) and the second output voltage (VNEG).

### Second Set

1. A method for controlling a DC-DC power converter, the method comprising: regulating a first output voltage (VPOS) at a first output (POS) of the DC-DC power converter based on a first predetermined or specified level, and a second output voltage (VNEG) at a second output (NEG) of the DC-DC power converter based on a second predetermined or specified level, by: controlling a plurality of switches of the DC-DC power converter so as to operate the DC-DC power converter with a mode when the input voltage (VIN) is greater than the magnitude of the first voltage (VPOS), wherein the mode comprises: a first phase wherein the plurality of switches are controlled to couple a first terminal of an inductor of the DC-DC power converter to the input (IN) and couple a second terminal of the inductor to the first output (POS) such that the inductor is charged by a current that flows between the input (IN) and the first output (POS); a second phase wherein the plurality of switches are controlled to couple the first terminal of the inductor to the input (IN) and couple the second terminal of the inductor to a reference voltage (GND) such that the inductor is charged by a current that flows between the input (IN) and the reference voltage (GND); and, a third phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND).
2. The method of clause 1, the method further comprising: controlling the plurality of switches of the DC-DC power converter so as to operate the DC-DC power converter to transition from the first phase to the second phase in response to a comparison of: the current that flows between the input (IN) and the first output (POS); and a current threshold.
3. The method of any preceding clause, wherein a stored inductor charge prior to the start of the mode is substantially the same as the stored inductor charge at the end of the mode.
4. The method of clause 3, the method further comprising adjusting the duration of the second phase such that the charge provided to the second output (NEG) during the third phase is substantially equal to the charge provided to the first output (POS) during the first phase.
5. The method of any preceding clause, wherein the DC-DC power converter is operated with the mode when the input voltage (VIN) is less than a sum of the magnitude of the first voltage (VPOS) and the magnitude of the second voltage (VNEG).
6. A method for controlling a DC-DC power converter, the method comprising: regulating a first output voltage (VPOS) at a first output (POS) of the DC-DC power converter based on a first predetermined or specified level, and a second output voltage (VNEG) at a second output (NEG) of the DC-DC power converter based on a second predetermined or specified level, by: controlling a plurality of switches of the DC-DC power converter so as to operate the DC-DC power converter with a mode when the input voltage (VIN) is less than the magnitude of the first voltage (VPOS), wherein the mode comprises: a first phase wherein the plurality of switches are controlled to couple a first terminal of an inductor of the DC-DC power converter to the input (IN) and couple a second terminal of the inductor to the reference voltage (GND) such that the inductor is charged by a current that flows between the input (IN) and the reference voltage (GND); a second phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND); and, a third phase wherein the plurality of switches are controlled to couple the first terminal of the inductor to the input (IN) and couple the second terminal of the inductor to the first output (POS) such that the inductor is discharged by a current that flows between the input (IN) and the first output (POS).
7. The method of clause 6, the method further comprising: controlling the plurality of switches of the DC-DC power converter so as to transition from the first phase to the second phase in response to a comparison of: the current that flows between the input (IN) and the reference voltage (GND); and a current threshold.
8. The method of any one of clauses 6 or 7, wherein a stored inductor charge prior to the start of the mode is substantially the same as the stored inductor charge at the end of the mode.
9. The method of clause 8, the method further comprising adjusting the duration of the second phase such that the charge provided to the second output (NEG) during the second phase is substantially equal to the charge provided to the first output (POS) during the third phase.
10. A method for controlling a DC-DC power converter, the method comprising: regulating a first output voltage (VPOS) at a first output (POS) of the DC-DC power converter based on a first predetermined or specified level, and a second output voltage (VNEG) at a second output (NEG) of the DC-DC power converter based on a second predetermined or specified level, by: controlling a plurality of switches of the DC-DC power converter so as to operate the DC-DC power converter with a mode, wherein the mode comprises: a first phase wherein the plurality of switches are controlled to couple a first terminal of an inductor of the DC-DC power converter to the input (IN) and couple a second terminal of the inductor to a reference voltage (GND) such that the inductor is charged by a current that flows between the input (IN) and the reference voltage (GND); a second phase wherein the plurality of switches are controlled to couple a first terminal of the inductor to the first output (POS) and couple a second terminal of the inductor to the second output (NEG) such that the inductor discharges and a current flows between the first output (POS) and the second output (NEG).
11. The method of clause 10, wherein the DC-DC power converter is operated with the mode when the input voltage (VIN) is greater than a sum of the magnitude of the first voltage (VPOS) and the magnitude of the second voltage (VNEG).
12. The method of any one of clauses 10 to 11, herein the mode further comprises a third phase wherein the plurality of switches are controlled to couple: a first terminal of the inductor to the first output (POS) and couple a second terminal of the inductor to the reference voltage (GND) such that the inductor discharges and a current flows between the first output (POS) and the reference voltage (GND); or a first terminal of the inductor to the second output (NEG) and couple a second terminal of the inductor to the reference voltage (GND) such that the inductor charges and a current flows between the second output (NEG) and the reference voltage (GND).
13. The method of any one of clauses 10 to 12, wherein in the third phase either the first terminal of the inductor is coupled to the first output or the second terminal of the inductor is coupled to the second output, based on the first output voltage (VPOS) and the second output voltage (VNEG).
14. The method of any one of clauses 10 to 13, the method further comprising: controlling the plurality of switches of the DC-DC power converter so as to operate the DC-DC power converter to transition from the first phase to the second phase in response to a comparison of: the current that flows between the input (IN) and the reference voltage (GND); and a current threshold.
15. The method of any one of clauses 10 to 14, wherein a stored inductor charge prior to the start of the mode is substantially the same as the stored inductor charge at the end of the mode.
16. The method of clause 15, the method further comprising adjusting the duration of the second phase such that the charge provided to the second output (NEG) is substantially equal to the charge provided to the first output (POS) during the mode.
17. A method for controlling a DC-DC power converter, the method comprising:
   regulating a first output voltage (VPOS) at a first output (POS) of the DC-DC power converter based on a first predetermined or specified level, and a second output voltage (VNEG) at a second output (NEG) of the DC-DC power converter based on a second predetermined or specified level, by:
      controlling a plurality of switches of the DC-DC power converter so as to operate the DC-DC power converter with a first mode when the input voltage (VIN) is greater than the first output voltage (VPOS); and
      controlling the plurality of switches to operate the DC-DC power converter with a second mode when the input voltage (VIN) is less than the first output voltage (VPOS),
   wherein the first mode is different to the second mode, and
   wherein the first mode and the second mode both comprise:
      a phase during which current flows at the first output; and
      a further phase during which current flows at the second output.
18. The method of clause 17, wherein the first mode comprises: a first phase wherein the plurality of switches are controlled to couple a first terminal of an inductor of the DC-DC power converter to the input (IN) and couple a second terminal of the inductor to the first output (POS) such that the inductor is charged by a current that flows between the input (IN) and the first output (POS);
   a second phase wherein the plurality of switches are controlled to couple the first terminal of the inductor to the input (IN) and couple the second terminal of the inductor to a reference voltage (GND) such that the inductor is charged by a current that flows between the input (IN) and the reference voltage (GND); and,
   a third phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND).
19. The method of clause 18, the method further comprising: controlling the plurality of switches of the DC-DC power converter so as to operate the DC-DC power converter to transition from the first phase to the second phase in response to a comparison of: the current that flows between the input (IN) and the first output (POS); and a first current threshold.
20. The method of any one of clauses 17 to 19, wherein for each of the first mode and/or the second mode, a stored inductor charge prior to the start of the mode is substantially the same as the stored inductor charge at the end of the mode.
21. The method of any one of clauses 17 to 20, wherein when the input voltage is greater than the first output voltage (VPOS) and less than a sum of a magnitude of the first voltage and a magnitude of the second voltage, controlling the plurality of switches so as to operate the DC-DC power converter with the first mode, and wherein the method further comprises:
   controlling the plurality of switches of the DC-DC power converter so as to operate the DC-DC power converter with a third mode when the input voltage is greater than the sum of the magnitude of the first voltage and the magnitude of the second voltage,
   wherein the third mode is different to the first mode and the second mode.
22. The method of clause 21, wherein the third mode comprises:
   a fourth phase wherein the plurality of switches are controlled to couple a first terminal of an inductor of the DC-DC power converter to the input (IN) and couple a second terminal of the inductor to a reference voltage (GND) such that the inductor is charged by a current that flows between the input (IN) and the reference voltage (GND); and
   a fifth phase wherein the plurality of switches are controlled to couple the first terminal of the inductor to the first output (POS) and couple the second terminal of the inductor to the second output (NEG) such that the inductor discharges and a current flows between the first output (POS) and the second output (NEG).
23. The method of clause 22, wherein the third mode further comprises a sixth phase wherein the plurality of switches are controlled to couple:
   the first terminal of the inductor to the first output (POS) and couple the second terminal of the inductor to the reference voltage (GND) such that the inductor discharges and a current flows between the first output (POS) and the reference voltage (GND); or
   the first terminal of the inductor to the second output (NEG) and couple the second terminal of the inductor to the reference voltage (GND) such that the inductor charges and a current flows between the second output (NEG) and the reference voltage (GND).
24. The method of clause 23, wherein in the sixth phase, the first terminal of the inductor is coupled to either the first output or the second output based on the first output voltage (VPOS) and the second output voltage (VNEG).
25. The method of any one of clauses 22 to 24, the method further comprising: controlling the plurality of switches of the DC-DC power converter so as to transition from the fourth phase to the fifth phase in response to a comparison of: the current that flows between the input (IN) and the reference voltage (GND); and a third current threshold.
26. The method of any one of clauses 22 to 25, wherein for the third mode, a stored inductor charge prior to the start of the third mode is substantially the same as the stored inductor charge at the end of the third mode
27. The method of any one of clauses 17 to 26, wherein the second mode comprises:
   a seventh phase wherein the plurality of switches are controlled to couple a first terminal of an inductor of the DC-DC power converter to the input (IN) and couple a second terminal of the inductor to the reference voltage (GND) such that the inductor is charged by a current that flows between the input (IN) and the reference voltage (GND);
   an eighth phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND); and,
   a ninth phase wherein the plurality of switches are controlled to couple the first terminal of the inductor to the input (IN) and couple the second terminal of the inductor to the first output (POS) such that the inductor is discharged by a current that flows between the input (IN) and the first output (POS).
28. The method of clause 27, the method further comprising: controlling the plurality of switches of the DC-DC power converter so as to transition from the seventh phase to the eighth phase in response to a comparison of: the current that flows between the input (IN) and the reference voltage; and a second current threshold.
29. A controller for controlling a DC-DC power converter, the controller being configured to:
   regulate a first output voltage (VPOS) at a first output (POS) of the DC-DC power converter based on a first predetermined or specified level, and a second output voltage (VNEG) at a second output (NEG) of the DC-DC power converter based on a second predetermined or specified level, by:
      controlling a plurality of switches of the DC-DC power converter so as to operate the DC-DC power converter with a first mode when the input voltage (VIN) is greater than the first output voltage (VPOS); and
      controlling the plurality of switches to operate the DC-DC power converter with a second mode when the input voltage (VIN) is less than the first output voltage (VPOS),
   wherein the first mode is different to the second mode, and
   wherein the first mode and the second mode both comprise:
      a phase during which current flows at the first output; and
      a further phase during which current flows at the second output.
30. The controller of clause 29, wherein the first mode comprises:
   a first phase wherein the plurality of switches are controlled to couple a first terminal of an inductor of the DC-DC power converter to the input (IN) and couple a second terminal of the inductor to the first output (POS) such that the inductor is charged by a current that flows between the input (IN) and the first output (POS);
   a second phase wherein the plurality of switches are controlled to couple the first terminal of the inductor to the input (IN) and couple the second terminal of the inductor to a reference voltage (GND) such that the inductor is charged by a current that flows between the input (IN) and the reference voltage (GND); and,
   a third phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND).
31. The controller of clause 30, further configured to: control the plurality of switches of the DC-DC power converter so as to operate the DC-DC power converter to transition from the first phase to the second phase in response to a comparison of: the current that flows between the input (IN) and the first output (POS); and a first current threshold.
32. The controller of any one of clauses 29 to 31, wherein for each of the first mode and/or the second mode, a stored inductor charge prior to the start of the mode is substantially the same as the stored inductor charge at the end of the mode.
33. The controller of any one of clauses 29 to 32, wherein when the input voltage is greater than the first output voltage (VPOS) and less than a sum of a magnitude of the first voltage and a magnitude of the second voltage, the controller is configured to control the plurality of switches so as to operate the DC-DC power converter with the first mode, and wherein the control is further configured to:
   control the plurality of switches of the DC-DC power converter so as to operate the DC-DC power converter with a third mode when the input voltage is greater than the sum of the magnitude of the first voltage and the magnitude of the second voltage,
   wherein the third mode is different to the first mode and the second mode.
34. The controller of clause 33, wherein the third mode comprises:
   a fourth phase wherein the plurality of switches are controlled to couple a first terminal of an inductor of the DC-DC power converter to the input (IN) and couple a second terminal of the inductor to a reference voltage (GND) such that the inductor is charged by a current that flows between the input (IN) and the reference voltage (GND); and
   a fifth phase wherein the plurality of switches are controlled to couple the first terminal of the inductor to the first output (POS) and couple the second terminal of the inductor to the second output (NEG) such that the inductor discharges and a current flows between the first output (POS) and the second output (NEG).
35. The controller of clause 34, wherein the third mode further comprises a sixth phase wherein the plurality of switches are controlled to couple:
   the first terminal of the inductor to the first output (POS) and couple the second terminal of the inductor to the reference voltage (GND) such that the inductor discharges and a current flows between the first output (POS) and the reference voltage (GND); or
   the first terminal of the inductor to the second output (NEG) and couple the second terminal of the inductor to the reference voltage (GND) such that the inductor charges and a current flows between the second output (NEG) and the reference voltage (GND).
36. The controller of clause 35, wherein in the sixth phase, controller is configured to control the DC-DC power converter such that the first terminal of the inductor is coupled to either the first output or the second output based on the first output voltage (VPOS) and the second output voltage (VNEG).
37. The controller of any one of clauses 34 to 36, wherein the controller is further configured to: control the plurality of switches of the DC-DC power converter so as to transition from the fourth phase to the fifth phase in response to a comparison of: the current that flows between the input (IN) and the reference voltage (GND); and a third current threshold.
38. The controller of any one of clauses 34 to 37, wherein for the third mode, a stored inductor charge prior to the start of the third mode is substantially the same as the stored inductor charge at the end of the third mode
39. The controller of any one of clauses 29 to 38, wherein the second mode comprises:
   a seventh phase wherein the plurality of switches are controlled to couple a first terminal of an inductor of the DC-DC power converter to the input (IN) and couple a second terminal of the inductor to the reference voltage (GND) such that the inductor is charged by a current that flows between the input (IN) and the reference voltage (GND);
   an eighth phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND); and,
   a ninth phase wherein the plurality of switches are controlled to couple the first terminal of the inductor to the input (IN) and couple the second terminal of the inductor to the first output (POS) such that the inductor is discharged by a current that flows between the input (IN) and the first output (POS).
40. The controller of clause 39, wherein the controller is further configured to control the plurality of switches of the DC-DC power converter so as to transition from the seventh phase to the eighth phase in response to a comparison of: the current that flows between the input (IN) and the reference voltage; and a second current threshold.
41. A controller for controlling a DC-DC power converter, the controller being configured to:
   regulate a first output voltage (VPOS) at a first output (POS) of the DC-DC power converter based on a first predetermined or specified level, and a second output voltage (VNEG) at a second output (NEG) of the DC-DC power converter based on a second predetermined or specified level, by:
      controlling a plurality of switches of the DC-DC power converter so as to operate the DC-DC power converter with a mode when the input voltage (VIN) is greater than the magnitude of the first voltage (VPOS), wherein the mode comprises:
         a first phase wherein the plurality of switches are controlled to couple a first terminal of an inductor of the DC-DC power converter to the input (IN) and couple a second terminal of the inductor to the first output (POS) such that the inductor is charged by a current that flows between the input (IN) and the first output (POS);
         a second phase wherein the plurality of switches are controlled to couple the first terminal of the inductor to the input (IN) and couple the second terminal of the inductor to a reference voltage (GND) such that the inductor is charged by a current that flows between the input (IN) and the reference voltage (GND); and,
         a third phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND).
42. The controller of clause 41, further configured to:
   control the plurality of switches of the DC-DC power converter so as to operate the DC-DC power converter to transition from the first phase to the second phase in response to a comparison of: the current that flows between the input (IN) and the first output (POS); and a current threshold.
43. The controller of clause 41 or clause 42, wherein a stored inductor charge prior to the start of the mode is substantially the same as the stored inductor charge at the end of the mode.
44. The controller of clause 43, further configured to adjust the duration of the second phase such that the charge provided to the second output (NEG) during the third phase is substantially equal to the charge provided to the first output (POS) during the first phase.
45. The controller of any of clauses 41 to 44, wherein the controller is configured to operate the DC-DC power converter with the mode when the input voltage (VIN) is less than a sum of the magnitude of the first voltage (VPOS) and the magnitude of the second voltage (VNEG).
46. A controller for controlling a DC-DC power converter, the controller being configured to: regulate a first output voltage (VPOS) at a first output (POS) of the DC-DC power converter based on a first predetermined or specified level, and a second output voltage (VNEG) at a second output (NEG) of the DC-DC power converter based on a second predetermined or specified level, by: controlling a plurality of switches of the DC-DC power converter so as to operate the DC-DC power converter with a mode when the input voltage (VIN) is less than the magnitude of the first voltage (VPOS), wherein the mode comprises: a first phase wherein the plurality of switches are controlled to couple a first terminal of an inductor of the DC-DC power converter to the input (IN) and couple a second terminal of the inductor to the reference voltage (GND) such that the inductor is charged by a current that flows between the input (IN) and the reference voltage (GND); a second phase wherein the plurality of switches are controlled to couple the first terminal of the inductor to the second output (NEG) and couple the second terminal of the inductor to a reference voltage (GND) such that the inductor is discharged by a current that flows between the second output (NEG) and the reference voltage (GND); and, a third phase wherein the plurality of switches are controlled to couple the first terminal of the inductor to the input (IN) and couple the second terminal of the inductor to the first output (POS) such that the inductor is discharged by a current that flows between the input (IN) and the first output (POS).
47. The controller of clause 46, further configured to control the plurality of switches of the DC-DC power converter so as to transition from the first phase to the second phase in response to a comparison of: the current that flows between the input (IN) and the reference voltage (GND); and a current threshold.
48. The controller of clause 46 or clause 47, wherein a stored inductor charge prior to the start of the mode is substantially the same as the stored inductor charge at the end of the mode.
49. The controller of clause 48, further configured to adjust the duration of the second phase such that the charge provided to the second output (NEG) during the second phase is substantially equal to the charge provided to the first output (POS) during the third phase.
50. A controller for controlling a DC-DC power converter, the controller being configured to: regulate a first output voltage (VPOS) at a first output (POS) of the DC-DC power converter based on a first predetermined or specified level, and a second output voltage (VNEG) at a second output (NEG) of the DC-DC power converter based on a second predetermined or specified level, by:
   controlling a plurality of switches of the DC-DC power converter so as to operate the DC-DC power converter with a mode, wherein the mode comprises:
      a first phase wherein the plurality of switches are controlled to couple a first terminal of an inductor of the DC-DC power converter to the input (IN) and couple a second terminal of the inductor to a reference voltage (GND) such that the inductor is charged by a current that flows between the input (IN) and the reference voltage (GND);
      a second phase wherein the plurality of switches are controlled to couple a first terminal of the inductor to the first output (POS) and couple a second terminal of the inductor to the second output (NEG) such that the inductor discharges and a current flows between the first output (POS) and the second output (NEG).
51. The controller of clause 50, wherein the DC-DC power converter is operated with the mode when the input voltage (VIN) is greater than a sum of the magnitude of the first voltage (VPOS) and the magnitude of the second voltage (VNEG),
52. The controller of clause 50 or clause 51, wherein the mode further comprises a third phase wherein the plurality of switches are controlled to couple:
   a first terminal of the inductor to the first output (POS) and couple a second terminal of the inductor to the reference voltage (GND) such that the inductor discharges and a current flows between the first output (POS) and the reference voltage (GND); or
   a first terminal of the inductor to the second output (NEG) and couple a second terminal of the inductor to the reference voltage (GND) such that the inductor charges and a current flows between the second output (NEG) and the reference voltage (GND).
53. The controller of any one of clauses 50 to 52, further configured to control the DC-DC power converter such that, in the third phase, either the first terminal of the inductor is coupled to the first output or the second terminal of the inductor is coupled to the second output, based on the first output voltage (VPOS) and the second output voltage (VNEG).
54. The controller of any one of clauses 50 to 53, further configured to: control the plurality of switches of the DC-DC power converter so as to operate the DC-DC power converter to transition from the first phase to the second phase in response to a comparison of: the current that flows between the input (IN) and the reference voltage (GND); and a current threshold.
55. The controller of any one of clauses 50 to 54, wherein a stored inductor charge prior to the start of the mode is substantially the same as the stored inductor charge at the end of the mode.
56. The controller of clause 55, further configured to adjust the duration of the second phase such that the charge provided to the second output (NEG) is substantially equal to the charge provided to the first output (POS) during the mode.
57. A DC-DC converter comprising: the controller of any of clauses 29 to 56; and a first plurality of switches, controlled by the controller.
58. An electronic device (such as a smart phone or a smart watch) comprising the DC-DC power converter of clause 57.
59. The electronic device of clause 58, further comprising a display coupled to the first output node and/or second output of the DC-DC power converter, such that at least one characteristic of the display (such as display power for brightness and/or pixel-level colour control) is controllable using the DC-DC power converter.

### Third Set

1. A controller for controlling a DC-DC power converter, the controller arranged to couple to a first output (POS) and a second output (NEG) of the DC-DC power converter, and configured to: receive a first output voltage (VPOS) from the first output (POS); receive a second output voltage (VNEG) from the second output (NEG); control a plurality of switches of a DC-DC power converter to operate the DC-DC power converter to generate a differential current pulse to: regulate the first output voltage (VPOS) based on a first predetermined or specified voltage level; and, regulate the second output voltage (VNEG) based on a second predetermined or specified voltage level; determine a load imbalance condition based on the first output voltage (VPOS), the second output voltage (VNEG), and an imbalance threshold; when the load imbalance condition is determined: the controller is configured to control the plurality of switches of the DC-DC power converter to operate the DC-DC power converter to generate a standalone current pulse to serve one of: the first output (POS); or, the second output (NEG).
2. The controller of clause 1, wherein the differential current pulse is generated by controlling the plurality of switches of the DC-DC power converter to operate the DC-DC power converter with a first mode comprising: a first phase during which an inductor of the DC-DC power converter is charged; a second phase during which the charge of the inductor is adjusted; and a third phase during which the inductor is discharged, wherein during at least one of the phases, current flows at the first output for serving the first output (POS), and wherein during at least one of the phases, current flows at the second output for serving the second output (NEG).
3. The controller of any one of clause 1 or 2, wherein the standalone current pulse to regulate the first output voltage (VPOS) is generated by controlling the plurality of switches of the DC-DC power converter to operate the DC-DC power converter with a second mode comprising: a fourth phase during which an inductor of the DC-DC power converter is charged until a current value through the inductor is equal to or greater than a first current threshold; and a fifth phase during which the charge of the inductor is adjusted and current flows at the first output (VPOS).
4. The controller of clause 3, further configured to: control the plurality of switches to end the fifth phase in response to determining that the current value through the inductor is substantially equal to a base current level, wherein the base current level is substantially equal to a current level immediately prior to the DC-DC power converter operating in the fourth phase of the second mode.
5. The controller of any one of clauses 3 or 4, wherein the second mode further comprises: a sixth phase during which the inductor is discharged and current flows at the first output (VPOS).
6. The controller of clause 5, wherein the controller is configured to control the plurality of switches to transition from the fifth phase to the sixth phase in response to a current value through the inductor reaching a second current threshold, or the expiry of a predetermined or specified timeout duration.
7. The controller of any preceding clause, wherein the standalone current pulse to regulate the second output voltage (VNEG) is generated by controlling the plurality of switches of a DC-DC power converter to operate the DC-DC power converter with a third mode comprising: a seventh phase during which an inductor of the DC-DC power converter is charged until a current value through the inductor is equal to or greater than a third current threshold; and, an eighth phase during which the charge of the inductor is discharged and current flows at the second output (VNEG).
8. The controller of any preceding clause, wherein the controller is configured to: compare a first signal corresponding to the first output voltage (VPOS), to a first regulation voltage level to generate a first comparison signal; and, compare a second signal corresponding to the second output voltage (VNEG), to a second regulation voltage level to generate a second comparison signal, wherein the load imbalance condition is determined when a difference of the first and second comparison signals is greater than an upper threshold or less than a lower threshold.
9. The controller of clause 8, wherein the controller comprises: a first Operational Transconductance amplifier (OTA) arranged to receive the first signal and the first regulation voltage level to generate the first comparison signal, wherein the first comparison signal is a current; a second OTA arranged to receive the second signal and the second regulation voltage level to generate the second comparison signal, wherein the second comparison signal is a current; a current subtractor circuit arranged to receive the first comparison signal and the second comparison signal to generate an imbalance signal; and, two comparators configured to determine the load imbalance condition, the two comparators configured to: compare the imbalance signal to the upper threshold and the lower threshold.
10. The controller of clause 9, wherein the two comparators are arranged in parallel.
11. The controller of any preceding clause, wherein the controller is configured to: determine a normal load condition based on the first output voltage (VPOS), the second output voltage (VNEG), and a second imbalance threshold; and when the normal load condition is determined: the controller is configured to control the plurality of switches of a DC-DC power converter to operate the DC-DC power converter with the differential current pulse to serve both the first output (POS) and the second output (NEG).
12. A controller for controlling a DC-DC power converter, the controller arranged to couple to a first output (POS), a second output (NEG), and a third output (AUX) of the DC-DC power converter, and configured to: receive a first output voltage (VPOS) from the first output (POS); receive a second output voltage (VNEG) at the second output (NEG); receive a third output voltage (VAUX) at the third output (AUX); generate a queue of requests for operating the DC-DC power converter, wherein the queue of requests is a First-In-First-Out, FIFO, queue, wherein each request of the queue of requests corresponds to one of the first, second, and third outputs for serving a respective one of the first, second, and third outputs; control a plurality of switches of a DC-DC power converter to operate the DC-DC power converter to generate one of a plurality of current pulses based on a first request of the queue of requests, wherein the plurality of current pulses comprises first, second, and third pulses, wherein during the first pulse, current flows at the first output (POS) for serving the first output, wherein during the second pulse, current flows at the second output (NEG) for serving the second output, wherein during the third pulse, current flows at the third output (AUX) for serving the third output; and, control a plurality of switches of a DC-DC power converter to operate the DC-DC power converter to generate one of a plurality of current pulses based on a second request of the queue of requests, after the DC-DC power converter is operated based on the first request.
13. The controller of clause 12, wherein the second pulse is the first pulse, and the first pulse is a differential current pulse, wherein the differential current pulse is based on the first request corresponding to one of the first and second outputs, wherein the differential current pulse regulates: the first output voltage (VPOS) based on a first predetermined or specified voltage level; and, the second output voltage (VNEG) based on a second predetermined or specified voltage level.
14. The controller of clause 12, wherein the first pulse is a first standalone current pulse, wherein the first standalone current pulse is based on the first request corresponding to the first output, wherein the first standalone current pulse regulates the first output voltage (VPOS) based on a first predetermined or specified voltage level.
15. The controller of any one of clauses 12 to 14, wherein the third pulse is a second standalone current pulse, wherein the second standalone current pulse is based on the second request corresponding to the third output, wherein the second standalone current pulse regulates the third output voltage (VAUX) based on a third predetermined or specified voltage level.
16. The controller of any one of clauses 12 to 15, wherein the controller configured to: integrate a comparison between the first output voltage (VPOS) to the first predetermined or specified voltage level to generate a first integrated signal; and compare the first integrated signal to a first regulation reference level to generate the first request (GO_P) corresponding to the first output; or integrate a comparison between the second output voltage (VNEG) to the second predetermined or specified voltage level to generate a second integrated signal; and compare the second integrated signal to a second regulation reference level to generate the first request (GO_N) corresponding to the second output.
17. The controller of any one of clauses 12 to 16, wherein the controller configured to: integrate a comparison between the third output voltage (VAUX) to the third predetermined or specified voltage level to generate a third integrated signal; and compare the third integrated signal to a third regulation reference level to generate the second request (GO_A) corresponding to the third output.
18. The controller of any one of clauses 12 to 17, wherein the third pulse is generated by controlling the plurality of switches of the DC-DC power converter to operate the DC-DC power converter with a mode comprising: a first phase during which an inductor of the DC-DC power converter is charged until a current value through the inductor is equal to or greater than a first current threshold ; and a second phase during which the charge of the inductor is adjusted and current flows at the third output (VAUX).
19. The controller of clause 18, wherein the controller is further configured to: control the plurality of switches to end the second phase in response to determining that the current is substantially equal to a base current level, wherein the base current level is substantially equal to a current level immediately prior to the DC-DC power converter operating in the first phase of the mode.
20. The controller of any one of clauses 18 or 19, wherein the second mode further comprises: a third phase during which the inductor is discharged and current flows at the third output (VAUX).
21. The controller of clause 20, wherein the controller is configured to control the plurality of switches to transition from the second phase to the third phase in response to a current value through the inductor reaching a second current threshold, or the expiry of a predetermined or specified timeout duration.
22. The controller of any one of clauses 12 to 21, wherein the plurality of current pulses comprises a third standalone current pulse, wherein the queue of requests comprises a third request corresponding to one of the first or second outputs, wherein the controller is further configured to: determine a load imbalance condition based on the first output voltage (VPOS), the second output voltage (VNEG), and an imbalance threshold; and when the third request is at the front of the queue of requests and the load imbalance condition is determined, control a plurality of switches of a DC-DC power converter to operate the DC-DC power converter to generate the third standalone current pulse based on the third request.
23. The controller of clause 22, wherein the third request is generated based on the first output voltage, wherein during the third standalone current pulse, current flows at the first output (POS) for serving the first output.
24. The controller of clause 22, wherein the third request is generated based on the second output voltage, wherein during the third standalone current pulse, current flows at the second output (NEG) for serving the second output,
25. The controller of any one of clauses 12 to 24, wherein the plurality of current pulses comprises a second differential current pulse, wherein the queue of requests comprises a third request corresponding to one of the first or second outputs, wherein the controller is further configured to: determine a normal load condition based on the first output voltage (VPOS), the second output voltage (VNEG), and a second imbalance threshold; and when the third request is at the front of the queue of requests and the normal load condition is determined, control a plurality of switches of a DC-DC power converter to operate the DC-DC power converter to generate the second differential current pulse corresponding to the third request.
26. A DC-DC power converter comprising the controller of any preceding clause.
27. An electronic device (such as a smart phone or a smart watch) comprising the DC-DC power converter of clause 26.
28. The electronic device of clause 27, further comprising a display coupled to the first output node and/or second output of the DC-DC power converter, such that at least one characteristic of the display (such as display power for brightness and/or pixel-level colour control) is controllable using the DC-DC power converter.
29. A method for controlling a DC-DC power converter, the method comprising: receive a first output voltage (VPOS) from the first output (POS); receive a second output voltage (VNEG) from the second output (NEG); control a plurality of switches of the DC-DC power converter to operate the DC-DC power converter to generate a differential current pulse to: regulate a first output voltage (VPOS) at a first output (POS) based on a first predetermined or specified voltage level; and, regulate the second output voltage (VNEG) at the second output (NEG) based on a second predetermined or specified voltage level; determine a load imbalance condition based on the first output voltage (VPOS), the second output voltage (VNEG), and an imbalance threshold; when the load imbalance condition is determined: the controller is configured to control the plurality of switches of the DC-DC power converter to operate the DC-DC power converter to generate a standalone current pulse to serve one of: the first output (POS); or, the second output (NEG).
30. The method of clause 29, wherein the differential current pulse is generated by controlling the plurality of switches of the DC-DC power converter to operate the DC-DC power converter with a first mode comprising: a first phase during which an inductor of the DC-DC power converter is charged; a second phase during which the charge of the inductor is adjusted; and a third phase during which the inductor is discharged, wherein during at least one of the phases, current flows at the first output for serving the first output (POS), and wherein during at least one of the phases, current flows at the second output for serving the second output (NEG).
31. The method of any one of clauses 29 or 30, wherein the standalone current pulse to regulate the first output voltage (VPOS) is generated by controlling the plurality of switches of the DC-DC power converter to operate the DC-DC power converter with a second mode comprising: a fourth phase during which an inductor of the DC-DC power converter is charged until a current value through the inductor is equal to or greater than a first current threshold; and a fifth phase during which the charge of the inductor is adjusted and current flows at the first output (VPOS).
32. The method of clause 31, further comprising: controlling the plurality of switches to end the fifth phase in response to determining that the current value through the inductor is substantially equal to a base current level, wherein the base current level is substantially equal to a current level immediately prior to the DC-DC power converter operating in the fourth phase of the second mode.
33. The method of any one of clauses 31 or 32, wherein the second mode further comprises: a sixth phase during which the inductor is discharged and current flows at the first output (VPOS).
34. The method of clause 33, further comprising controlling the plurality of switches to transition from the fifth phase to the sixth phase in response to a current value through the inductor reaching a second current threshold, or the expiry of a predetermined or specified timeout duration.
35. The method of any of clauses 29 to 34, wherein the standalone current pulse to regulate the second output voltage (VNEG) is generated by controlling the plurality of switches of a DC-DC power converter to operate the DC-DC power converter with a third mode comprising: a seventh phase during which an inductor of the DC-DC power converter is charged until a current value through the inductor is equal to or greater than a third current threshold; and, an eighth phase during which the charge of the inductor is discharged and current flows at the second output (VNEG).
36. The method of any of clauses 29 to 35, further comprising: comparing a first signal corresponding to the first output voltage (VPOS), to a first regulation voltage level to generate a first comparison signal; and, comparing a second signal corresponding to the second output voltage (VNEG), to a second regulation voltage level to generate a second comparison signal, wherein the load imbalance condition is determined when a difference of the first and second comparison signals is greater than an upper threshold or less than a lower threshold.
37. The method of any of clauses 29 to 36, further comprising: determining a normal load condition based on the first output voltage (VPOS), the second output voltage (VNEG), and a second imbalance threshold; and when the normal load condition is determined: controlling the plurality of switches of a DC-DC power converter to operate the DC-DC power converter with the differential current pulse to serve both the first output (POS) and the second output (NEG).
38. A method for controlling a DC-DC power converter, the DC-DC power converter comprising a first output (POS), a second output (NEG), and a third output (AUX), the method comprising: generate a queue of requests for operating the DC-DC power converter, wherein the queue of requests is a First-In-First-Out, FIFO, queue, wherein each request of the queue of requests corresponds to one of the first, second, and third outputs for serving a respective one of the first, second, and third outputs; control a plurality of switches of a DC-DC power converter to operate the DC-DC power converter to generate one of a plurality of current pulses based on a first request of the queue of requests, wherein the plurality of current pulses comprises first, second, and third pulses, wherein during the first pulse, current flows at the first output (POS) for serving the first output, wherein during the second pulse, current flows at the second output (NEG) for serving the second output, wherein during the third pulse, current flows at the third output (AUX) for serving the third output; and, control a plurality of switches of a DC-DC power converter to operate the DC-DC power converter to generate one of a plurality of current pulses based on a second request of the queue of requests, after the DC-DC power converter is operated based on the first request.
39. The method of clause 38, wherein the second pulse is the first pulse, and the first pulse is a differential current pulse, wherein the differential current pulse is based on the first request corresponding to one of the first and second outputs, wherein the differential current pulse regulates: the first output voltage (VPOS) based on a first predetermined or specified voltage level; and, the second output voltage (VNEG) based on a second predetermined or specified voltage level.
40. The method of clause 38, wherein the first pulse is a first standalone current pulse, wherein the first standalone current pulse is based on the first request corresponding to the first output, wherein the first standalone current pulse regulates the first output voltage (VPOS) based on a first predetermined or specified voltage level.
41. The method of any one of clauses 38 to 40, wherein the third pulse is a second standalone current pulse, wherein the second standalone current pulse is based on the second request corresponding to the third output, wherein the second standalone current pulse regulates the third output voltage (VAUX) based on a third predetermined or specified voltage level.
42. The method of any one of clauses 38 to 41, further comprising: integrating a comparison between the first output voltage (VPOS) to the first predetermined or specified voltage level to generate a first integrated signal; and comparing the first integrated signal to a first regulation reference level to generate the first request (GO_P) corresponding to the first output; or integrating a comparison between the second output voltage (VNEG) to the second predetermined or specified voltage level to generate a second integrated signal; and comparing the second integrated signal to a second regulation reference level to generate the first request (GO_N) corresponding to the second output.
43. The method of any one of clauses 38 to 42, further comprising: integrating a comparison between the third output voltage (VAUX) to the third predetermined or specified voltage level to generate a third integrated signal; and comparing the third integrated signal to a third regulation reference level to generate the second request (GO_A) corresponding to the third output.
44. The method of any one of clauses 38 to 43, wherein the third pulse is generated by controlling the plurality of switches of the DC-DC power converter to operate the DC-DC power converter with a mode comprising: a first phase during which an inductor of the DC-DC power converter is charged until a current value through the inductor is equal to or greater than a first current threshold; and a second phase during which the charge of the inductor is adjusted and current flows at the third output (VAUX).
45. The method of clause 44, further comprising: controlling the plurality of switches to end the second phase in response to determining that the current is substantially equal to a base current level, wherein the base current level is substantially equal to a current level immediately prior to the DC-DC power converter operating in the first phase of the mode.
46. The method of any one of clauses 44 or 45, wherein the second mode further comprises: a third phase during which the inductor is discharged and current flows at the third output (VAUX).
47. The method of clause 46, further comprising controlling the plurality of switches to transition from the second phase to the third phase in response to a current value through the inductor reaching a second current threshold, or the expiry of a predetermined or specified timeout duration.
48. The controller of any one of clauses 38 to 47, wherein the plurality of current pulses comprises a third standalone current pulse, wherein the queue of requests comprises a third request corresponding to one of the first or second outputs, wherein the method further comprises: determining a load imbalance condition based on the first output voltage (VPOS), the second output voltage (VNEG), and an imbalance threshold; and when the third request is at the front of the queue of requests and the load imbalance condition is determined, controlling a plurality of switches of a DC-DC power converter to operate the DC-DC power converter to generate the third standalone current pulse based on the third request.
49. The method of clause 48, wherein the third request is generated based on the first output voltage, wherein during the third standalone current pulse, current flows at the first output (POS) for serving the first output.
50. The method of clause 48, wherein the third request is generated based on the second output voltage, wherein during the third standalone current pulse, current flows at the second output (NEG) for serving the second output,
51. The method of any one of clauses 38 to 50, wherein the plurality of current pulses comprises a second differential current pulse, wherein the queue of requests comprises a third request corresponding to one of the first or second outputs, wherein the method further comprises: determining a normal load condition based on the first output voltage (VPOS), the second output voltage (VNEG), and a second imbalance threshold; and when the third request is at the front of the queue of requests and the normal load condition is determined, controlling a plurality of switches of a DC-DC power converter to operate the DC-DC power converter to generate the second differential current pulse corresponding to the third request.

1. A method for controlling a DC-DC power converter, the method comprising:
regulating a first output voltage at a first output of the DC-DC power converter based on a first specified level, and a second output voltage at a second output of the DC-DC power converter based on a second specified level, by:
controlling a plurality of switches of the DC-DC power converter so as to operate the DC-DC power converter with a mode when an input voltage is greater than a magnitude of the first voltage, wherein the mode comprises:
a first phase wherein the plurality of switches are controlled to couple a first terminal of an inductor of the DC-DC power converter to the input and couple a second terminal of the inductor to the first output such that the inductor is charged by a current that flows between the input and the first output;
a second phase wherein the plurality of switches are controlled to couple the first terminal of the inductor to the input and couple the second terminal of the inductor to a reference voltage such that the inductor is charged by a current that flows between the input and the reference voltage; and,
a third phase wherein the plurality of switches are controlled to couple the first terminal of the inductor to the second output and couple the second terminal of the inductor to a reference voltage such that the inductor is discharged by a current that flows between the second output and the reference voltage.

2. The method of claim 1, the method further comprising:
controlling the plurality of switches of the DC-DC power converter so as to operate the DC-DC power converter to transition from the first phase to the second phase in response to a comparison of: the current that flows between the input and the first output; and a current threshold.

3. The method of claim 1, wherein a stored inductor charge prior to a start of the mode is substantially the same as the stored inductor charge at an end of the mode.

4. The method of claim 3, the method further comprising adjusting a duration of the second phase such that the charge provided to the second output during the third phase is substantially equal to the charge provided to the first output during the first phase.

5. The method of claim 1, wherein the DC-DC power converter is operated with the mode when the input voltage is less than a sum of the magnitude of the first voltage and the magnitude of the second voltage 6. A method for controlling a DC-DC power converter, the method comprising:
regulating a first output voltage at a first output of the DC-DC power converter based on a first specified level, and a second output voltage at a second output (NEG) of the DC-DC power converter based on a second specified level, by:
controlling a plurality of switches of the DC-DC power converter so as to operate the DC-DC power converter with a mode when an input voltage is less than a magnitude of the first voltage, wherein the mode comprises:
a first phase wherein the plurality of switches are controlled to couple a first terminal of an inductor of the DC-DC power converter to the input and couple a second terminal of the inductor to a reference voltage such that the inductor is charged by a current that flows between the input and the reference voltage;
a second phase wherein the plurality of switches are controlled to couple the first terminal of the inductor to the second output and couple the second terminal of the inductor to a reference voltage such that the inductor is discharged by a current that flows between the second output and the reference voltage; and,
a third phase wherein the plurality of switches are controlled to couple the first terminal of the inductor to the input and couple the second terminal of the inductor to the first output such that the inductor is discharged by a current that flows between the input and the first output.

7. The method of claim 6, the method further comprising: controlling the plurality of switches of the DC-DC power converter so as to transition from the first phase to the second phase in response to a comparison of: the current that flows between the input and the reference voltage; and a current threshold.

8. The method of claim 6, wherein a stored inductor charge prior to a start of the mode is substantially the same as the stored inductor charge at an end of the mode.

9. The method of claim 8, the method further comprising adjusting a duration of the second phase such that the charge provided to the second output during the second phase is substantially equal to the charge provided to the first output during the third phase.

10. A method for controlling a DC-DC power converter, the method comprising:
regulating a first output voltage (at a first output of the DC-DC power converter based on a first specified level, and a second output voltage at a second output (NEG) of the DC-DC power converter based on a second specified level, by:
controlling a plurality of switches of the DC-DC power converter so as to operate the DC-DC power converter with a mode, wherein the mode comprises:
a first phase wherein the plurality of switches are controlled to couple a first terminal of an inductor of the DC-DC power converter to an input and couple a second terminal of the inductor to a reference voltage such that the inductor is charged by a current that flows between the input and the reference voltage; and
a second phase wherein the plurality of switches are controlled to couple a first terminal of the inductor to the first output and couple a second terminal of the inductor to the second output such that the inductor discharges and a current flows between the first output and the second output.

11. The method of claim 10, wherein the DC-DC power converter is operated with the mode when the input voltage is greater than a sum of a magnitude of the first voltage and a magnitude of the second voltage).

12. The method of claim 10, herein the mode further comprises a third phase wherein the plurality of switches are controlled to couple:
a first terminal of the inductor to the first output and couple a second terminal of the inductor to the reference voltage such that the inductor discharges and a current flows between the first output and the reference voltage; or
a first terminal of the inductor to the second output and couple a second terminal of the inductor to the reference voltage such that the inductor charges and a current flows between the second output and the reference voltage.

13. The method of claim 10, wherein in a third phase either the first terminal of the inductor is coupled to the first output or the second terminal of the inductor is coupled to the second output, based on the first output voltage and the second output voltage.

14. The method of claim 10, the method further comprising: controlling the plurality of switches of the DC-DC power converter so as to operate the DC-DC power converter to transition from the first phase to the second phase in response to a comparison of: the current that flows between the input and the reference voltage; and a current threshold.

15. The method of claim 10, wherein a stored inductor charge prior to a start of the mode is substantially the same as the stored inductor charge at an end of the mode.

16. The method of claim 15, the method further comprising adjusting a duration of the second phase such that the charge provided to the second output is substantially equal to the charge provided to the first output during the mode.

17. A controller for controlling a DC-DC power converter, the controller being configured to:
regulate a first output voltage at a first output of the DC-DC power converter based on a first specified level, and a second output voltage at a second output of the DC-DC power converter based on a second specified level, by:
controlling a plurality of switches of the DC-DC power converter so as to operate the DC-DC power converter with a mode when an input voltage is less than a magnitude of the first voltage, wherein the mode comprises:
a first phase wherein the plurality of switches are controlled to couple a first terminal of an inductor of the DC-DC power converter to the input and couple a second terminal of the inductor to a reference voltage such that the inductor is charged by a current that flows between the input and the reference voltage;
a second phase wherein the plurality of switches are controlled to couple the first terminal of the inductor to the second output and couple the second terminal of the inductor to a reference voltage such that the inductor is discharged by a current that flows between the second output and the reference voltage; and,
a third phase wherein the plurality of switches are controlled to couple the first terminal of the inductor to the input and couple the second terminal of the inductor to the first output such that the inductor is discharged by a current that flows between the input and the first output.

18. The controller of claim 17, further configured to control the plurality of switches of the DC-DC power converter so as to transition from the first phase to the second phase in response to a comparison of: the current that flows between the input and the reference voltage; and a current threshold.

19. The controller of claim 17, wherein a stored inductor charge prior to a start of the mode is substantially the same as the stored inductor charge at an end of the mode.

20. The controller of claim 19, further configured to adjust a duration of the second phase such that the charge provided to the second output during the second phase is substantially equal to the charge provided to the first output during the third phase.
